(19) United States
(12) Patent Application Publication
(10) Pub. No.: US 2026/0040370 A1
(43) Pub. Date: Feb. 5, 2026

(54) MULTIPLE PHYSICAL RANDOM ACCESS CHANNEL TRANSMISSIONS

(71) Applicant: QUALCOMM Incorporated, San Diego, CA (US)

(72) Inventors: Hung Dinh LY, San Diego, CA (US); Mahmoud TAHERZADEH BOROUJENI, San Diego, CA (US); Kexin XIAO, Shanghai (CN); Gokul SRIDHARAN, Sunnyvale, CA (US)

(21) Appl. No.: 19/099,646

(22) PCT Filed: Sep. 30, 2022
(86) PCT No.: PCT/CN2022/123096

§ 371 Date: Jan. 29, 2025

(51) Int. Cl. H04W 74/0833; H04W 56/00; H04W 74/00; H04W 74/0838

(52) U.S. Cl. CPC H04W 74/0841; H04W 56/0015; H04W 74/006; H04W 74/0838

(57) ABSTRACT

Various aspects of the present disclosure generally relate to wireless communication. In some aspects, a user equipment (UE) may receive, from a network node, physical random access channel (PRACH) transmission counting control information. The UE may transmit, to the network node, multiple PRACH transmissions in a random access procedure in accordance with the PRACH transmission counting control information. Numerous other aspects are described.

### FIELD OF THE DISCLOSURE

Aspects of the present disclosure generally relate to wireless communication and to techniques and apparatuses for multiple physical access channel (PRACH) transmissions in a random access procedure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a user equipment (UE). The method may include receiving, from a network node, physical random access channel (PRACH) transmission counting control information. The method may include transmitting, to the network node, multiple PRACH transmissions in a random access procedure in accordance with the PRACH transmission counting control information.

Some aspects described herein relate to a method of wireless communication performed by an apparatus of a network node. The method may include transmitting PRACH transmission counting control information. The method may include receiving, from a UE, multiple PRACH transmissions in a random access procedure in accordance with the PRACH transmission counting control information.

Some aspects described herein relate to a method of wireless communication performed by an apparatus of a UE. The method may include receiving, from a network node while operating in a connected state, configuration information that indicates dedicated random access channel (RACH) resources for multiple PRACH transmissions. The method may include transmitting, to the network node, the multiple PRACH transmissions, in a contention based random access (CBRA) procedure, using the dedicated RACH resources.

Some aspects described herein relate to a method of wireless communication performed by an apparatus of a network node. The method may include transmitting, to a UE while the UE is operating in a connected state, configuration information that indicates dedicated RACH resources for multiple PRACH transmissions. The method may include receiving, from the UE, the multiple PRACH transmissions, in a CBRA procedure, using the dedicated RACH resources.

Some aspects described herein relate to a method of wireless communication performed by an apparatus of a UE. The method may include receiving, from a first network node, a configuration for a dual active protocol stack (DAPS) based handover from the first network node to a second network node. The method may include transmitting, during the DAPS based handover, an uplink transmission to the second network node. The method may include transmitting, during the DAPS based handover, multiple PRACH transmissions to the first network node in respective RACH occasions, in accordance with a rule for counting a PRACH transmission that is dropped in connection with a RACH occasion associated with the PRACH transmission overlapping in time with the uplink transmission to the second network node.

Some aspects described herein relate to a method of wireless communication performed by an apparatus of a first network node. The method may include transmitting, to a UE, a configuration for a DAPS based handover from the first network node to a second network node. The method may include receiving, from the UE during the DAPS based handover, multiple PRACH transmissions in respective RACH occasions, in accordance with a rule for counting a PRACH transmission that is dropped in connection with a RACH occasion associated with the PRACH transmission overlapping in time with an uplink transmission to the second network node.

Some aspects described herein relate to a UE for wireless communication. The UE may include a memory, a transceiver, and one or more processors coupled to the memory and the transceiver. The one or more processors may be configured to receive, via the transceiver and from a network node, PRACH transmission counting control information. The one or more processors may be configured to transmit, via the transceiver and to the network node, multiple PRACH transmissions in a random access procedure in accordance with the PRACH transmission counting control information.

Some aspects described herein relate to a network node for wireless communication. The network node may include a memory and one or more processors coupled to the memory. The one or more processors may be configured to transmit PRACH transmission counting control information. The one or more processors may be configured to receive, from a UE, multiple PRACH transmissions in a random access procedure in accordance with the PRACH transmission counting control information.

Some aspects described herein relate to a UE for wireless communication. The UE may include a memory, a transceiver, and one or more processors coupled to the memory and the transceiver. The one or more processors may be configured to receive, via the transceiver and from a network node while operating in a connected state, configuration information that indicates dedicated RACH resources for multiple PRACH transmissions. The one or more processors may be configured to transmit, via the transceiver and to the network node, the multiple PRACH transmissions, in a CBRA procedure, using the dedicated RACH resources.

Some aspects described herein relate to a network node for wireless communication. The network node may include a memory and one or more processors coupled to the memory. The one or more processors may be configured to transmit, to a UE while the UE is operating in a connected state, configuration information that indicates dedicated RACH resources for multiple PRACH transmissions. The one or more processors may be configured to receive, from the UE, the multiple PRACH transmissions, in a CBRA procedure, using the dedicated RACH resources.

Some aspects described herein relate to a UE for wireless communication. The UE may include a memory, a transceiver, and one or more processors coupled to the memory and the transceiver. The one or more processors may be configured to receive, via the transceiver and from a first network node, a configuration for a DAPS based handover from the first network node to a second network node. The one or more processors may be configured to transmit, via the transceiver and during the DAPS based handover, an uplink transmission to the second network node. The one or more processors may be configured to transmit, via the transceiver during the DAPS based handover, multiple PRACH transmissions to the first network node in respective RACH occasions, in accordance with a rule for counting a PRACH transmission that is dropped in connection with a RACH occasion associated with the PRACH transmission overlapping in time with the uplink transmission to the second network node.

Some aspects described herein relate to a first network node for wireless communication. The first network node may include a memory, a transceiver, and one or more processors coupled to the memory and the transceiver. The one or more processors may be configured to transmit, via the transceiver to a UE, a configuration for a DAPS based handover from the first network node to a second network node. The one or more processors may be configured to receive, from the UE during the DAPS based handover, multiple PRACH transmissions in respective RACH occasions, in accordance with a rule for counting a PRACH transmission that is dropped in connection with a RACH occasion associated with the PRACH transmission overlapping in time with an uplink transmission to the second network node.

Some aspects described herein relate to a non-transitory computer-readable medium that stores a set of instructions for wireless communication by a UE. The set of instructions, when executed by one or more processors of the UE, may cause the UE to receive, from a network node, PRACH transmission counting control information. The set of instructions, when executed by one or more processors of the UE, may cause the UE to transmit, to the network node, multiple PRACH transmissions in a random access procedure in accordance with the PRACH transmission counting control information.

Some aspects described herein relate to a non-transitory computer-readable medium that stores a set of instructions for wireless communication by a network node. The set of instructions, when executed by one or more processors of the network node, may cause the network node to transmit PRACH transmission counting control information. The set of instructions, when executed by one or more processors of the network node, may cause the network node to receive, from a UE, multiple PRACH transmissions in a random access procedure in accordance with the PRACH transmission counting control information.

Some aspects described herein relate to a non-transitory computer-readable medium that stores a set of instructions for wireless communication by a UE. The set of instructions, when executed by one or more processors of the UE, may cause the UE to receive, from a network node while operating in a connected state, configuration information that indicates dedicated RACH resources for multiple PRACH transmissions. The set of instructions, when executed by one or more processors of the UE, may cause the UE to transmit, to the network node, the multiple PRACH transmissions, in a CBRA procedure, using the dedicated RACH resources.

Some aspects described herein relate to a non-transitory computer-readable medium that stores a set of instructions for wireless communication by a network node. The set of instructions, when executed by one or more processors of the network node, may cause the network node to transmit, to a UE while the UE is operating in a connected state, configuration information that indicates dedicated RACH resources for multiple PRACH transmissions. The set of instructions, when executed by one or more processors of the network node, may cause the network node to receive, from the UE, the multiple PRACH transmissions, in a CBRA procedure, using the dedicated RACH resources.

Some aspects described herein relate to a non-transitory computer-readable medium that stores a set of instructions for wireless communication by an UE. The set of instructions, when executed by one or more processors of the UE, may cause the UE to receive, from a first network node, a configuration for a DAPS based handover from the first network node to a second network node. The set of instructions, when executed by one or more processors of the UE, may cause the UE to transmit, during the DAPS based handover, an uplink transmission to the second network node. The set of instructions, when executed by one or more processors of the UE, may cause the UE to transmit, during the DAPS based handover, multiple PRACH transmissions to the first network node in respective RACH occasions, in accordance with a rule for counting a PRACH transmission that is dropped in connection with a RACH occasion associated with the PRACH transmission overlapping in time with the uplink transmission to the second network node.

Some aspects described herein relate to a non-transitory computer-readable medium that stores a set of instructions for wireless communication by a first network node. The set of instructions, when executed by one or more processors of the first network node, may cause the first network node to transmit, to a UE, a configuration for a DAPS based handover from the first network node to a second network node. The set of instructions, when executed by one or more processors of the first network node, may cause the first network node to receive, from the UE during the DAPS based handover, multiple PRACH transmissions in respective RACH occasions, in accordance with a rule for counting a PRACH transmission that is dropped in connection with a RACH occasion associated with the PRACH transmission overlapping in time with an uplink transmission to the second network node.

Some aspects described herein relate to an apparatus for wireless communication. The apparatus may include means for receiving, from a network node, PRACH transmission counting control information. The apparatus may include means for transmitting, to the network node, multiple PRACH transmissions in a random access procedure in accordance with the PRACH transmission counting control information.

Some aspects described herein relate to an apparatus for wireless communication. The apparatus may include means for transmitting PRACH transmission counting control information. The apparatus may include means for receiving, from a UE, multiple PRACH transmissions in a random access procedure in accordance with the PRACH transmission counting control information.

Some aspects described herein relate to an apparatus for wireless communication. The apparatus may include means for receiving, from a network node while operating in a connected state, configuration information that indicates dedicated RACH resources for multiple PRACH transmissions. The apparatus may include means for transmitting, to the network node, the multiple PRACH transmissions, in a CBRA procedure, using the dedicated RACH resources.

Some aspects described herein relate to an apparatus for wireless communication. The apparatus may include means for transmitting, to a UE while the UE is operating in a connected state, configuration information that indicates dedicated RACH resources for multiple PRACH transmissions. The apparatus may include means for receiving, from the UE, the multiple PRACH transmissions, in a CBRA procedure, using the dedicated RACH resources.

Some aspects described herein relate to an apparatus for wireless communication. The apparatus may include means for receiving, from a first network node, a configuration for a DAPS based handover from the first network node to a second network node. The apparatus may include means for transmitting, during the DAPS based handover, an uplink transmission to the second network node. The apparatus may include means for transmitting, during the DAPS based handover, multiple PRACH transmissions to the first network node in respective RACH occasions, in accordance with a rule for counting a PRACH transmission that is dropped in connection with a RACH occasion associated with the PRACH transmission overlapping in time with the uplink transmission to the second network node.

Some aspects described herein relate to an apparatus for wireless communication. The apparatus may include means for transmitting, to a UE, a configuration for a DAPS based handover from the apparatus to a target network node. The apparatus may include means for receiving, from the UE during the DAPS based handover, multiple PRACH transmissions in respective RACH occasions, in accordance with a rule for counting a PRACH transmission that is dropped in connection with a RACH occasion associated with the PRACH transmission overlapping in time with an uplink transmission to the target network node.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a four-step random access procedure, in accordance with the present disclosure.

FIGS. 5-7 are diagrams illustrating examples associated with multiple physical random access channel (PRACH) transmissions in a random access procedure, in accordance with the present disclosure.

FIGS. 8-13 are diagrams illustrating example processes associated with multiple PRACH transmissions in a random access procedure, in accordance with the present disclosure.

FIGS. 14-15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

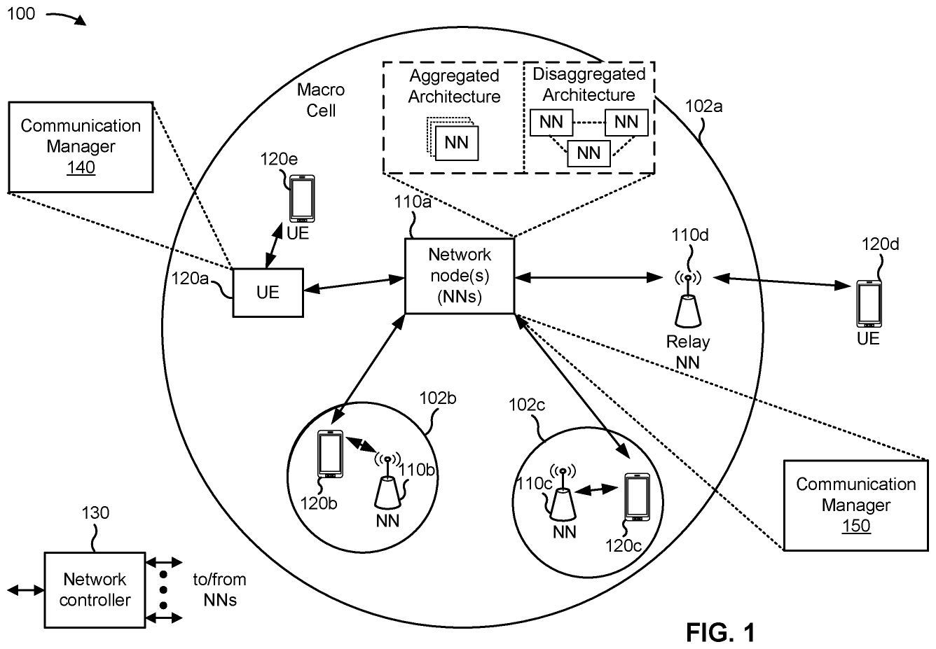

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, physical random access channel (PRACH) transmission counting control information; and transmit, to the network node, multiple PRACH transmissions in a random access procedure in accordance with the PRACH transmission counting control information. Additionally, or alternatively, the communication manager 140 may perform one or more other operations described herein.

In some aspects, as described in more detail elsewhere herein, the communication manager 140 may receive, from a network node while operating in a connected state, configuration information that indicates dedicated random access channel (RACH) resources for multiple PRACH transmissions; and transmit, to the network node, the multiple PRACH transmissions, in a contention based random access (CBRA) procedure, using the dedicated RACH resources. Additionally, or alternatively, the communication manager 140 may perform one or more other operations described herein.

In some aspects, as described in more detail elsewhere herein, the communication manager 140 may receive, from a first network node, a configuration for a dual active protocol stack (DAPS) based handover from the first network node to a second network node; transmit, during the DAPS based handover, an uplink transmission to the second network node; and transmit, during the DAPS based handover, multiple PRACH transmissions to the first network node in respective RACH occasions, in accordance with a rule for counting a PRACH transmission that is dropped in connection with a RACH occasion associated with the PRACH transmission overlapping in time with the uplink transmission to the second network node. Additionally, or alternatively, the communication manager 140 may perform one or more other operations described herein.

In some aspects, the network node 110 may include a communication manager 150. As described in more detail elsewhere herein, the communication manager 150 may transmit PRACH transmission counting control information; and receive, from a UE, multiple PRACH transmissions in a random access procedure in accordance with the PRACH transmission counting control information. Additionally, or alternatively, the communication manager 150 may perform one or more other operations described herein.

In some aspects, as described in more detail elsewhere herein, the communication manager 150 may transmit, to a UE while the UE is operating in a connected state, configuration information that indicates dedicated RACH resources for multiple PRACH transmissions; and receive, from the UE, the multiple PRACH transmissions, in a CBRA procedure, using the dedicated RACH resources. Additionally, or alternatively, the communication manager 150 may perform one or more other operations described herein.

In some aspects, as described in more detail elsewhere herein, the communication manager 150 of a first network node may transmit, to a UE, a configuration for a DAPS based handover from the first network node to a second network node; and receive, from the UE during the DAPS based handover, multiple PRACH transmissions in respective RACH occasions, in accordance with a rule for counting a PRACH transmission that is dropped in connection with a RACH occasion associated with the PRACH transmission overlapping in time with an uplink transmission to the second network node. Additionally, or alternatively, the communication manager 150 may perform one or more other operations described herein.

As indicated above, FIG. 1 is provided as an example. Other examples may differ from what is described with regard to FIG. 1.

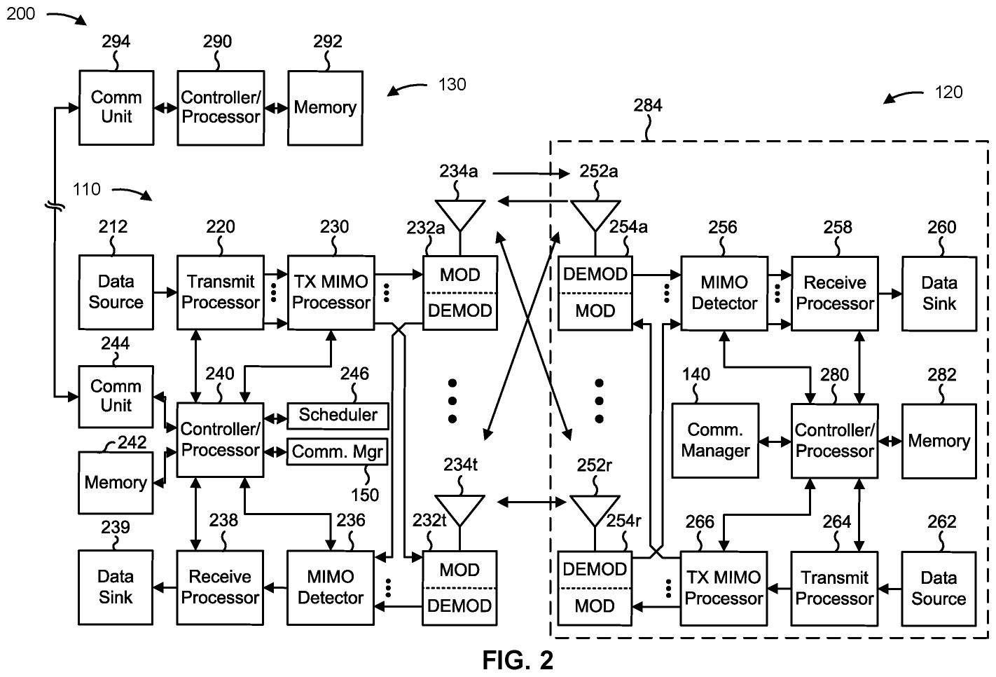

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

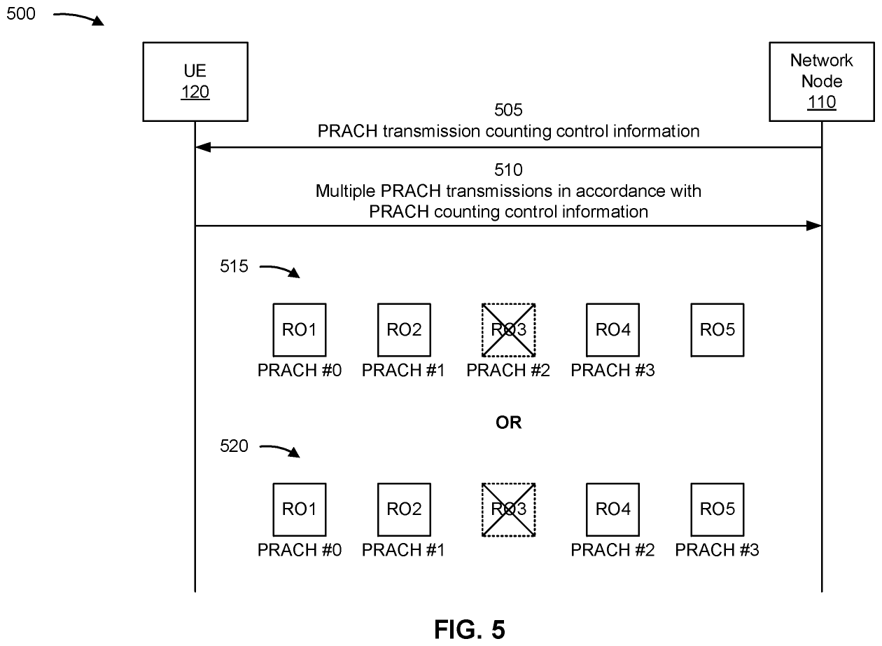

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-15).

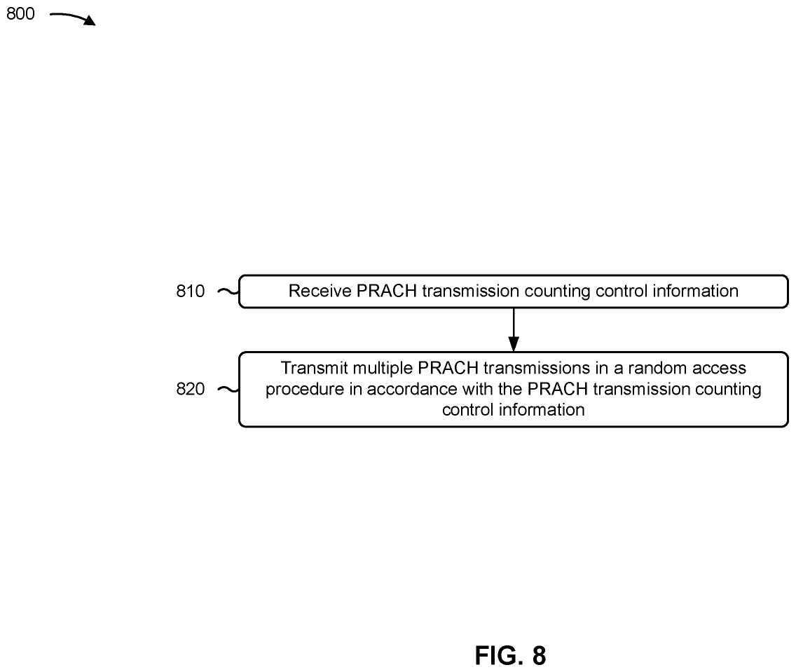

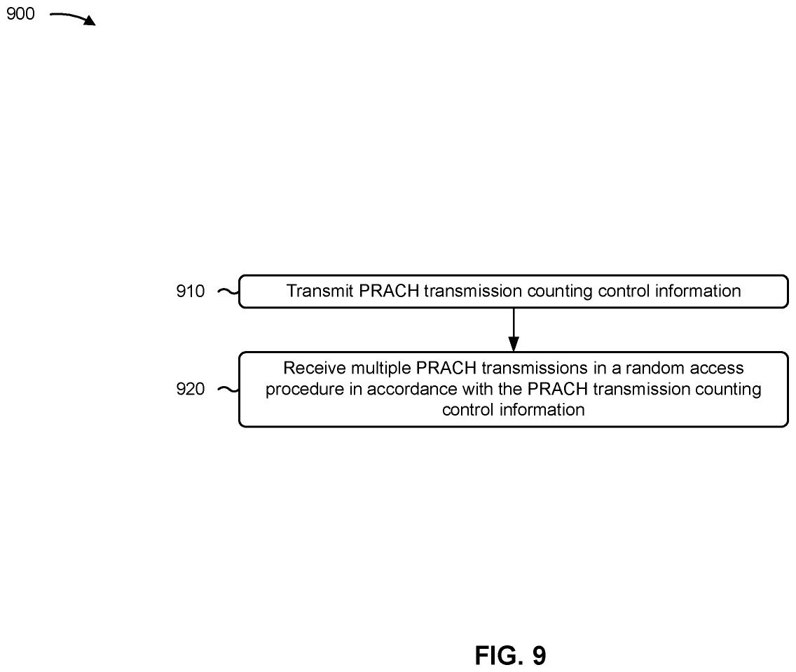

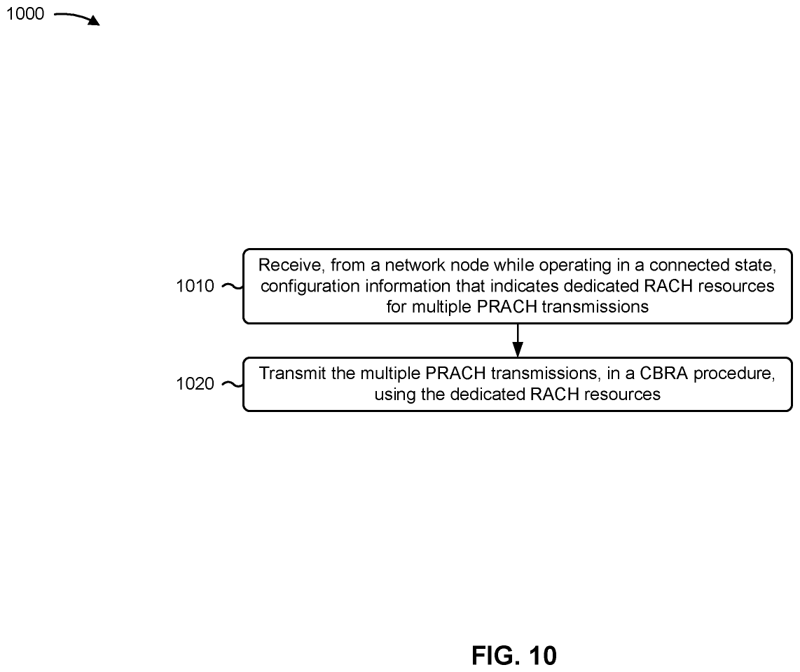

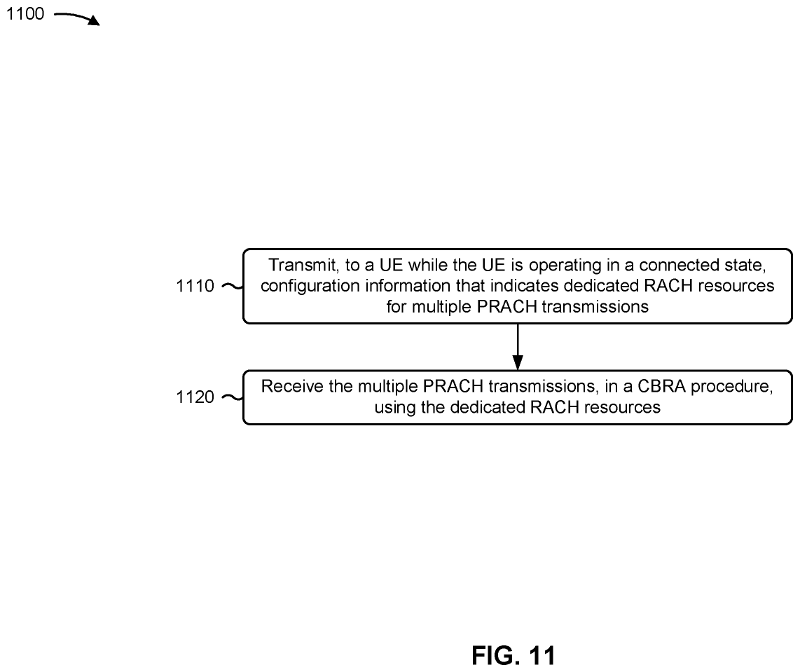

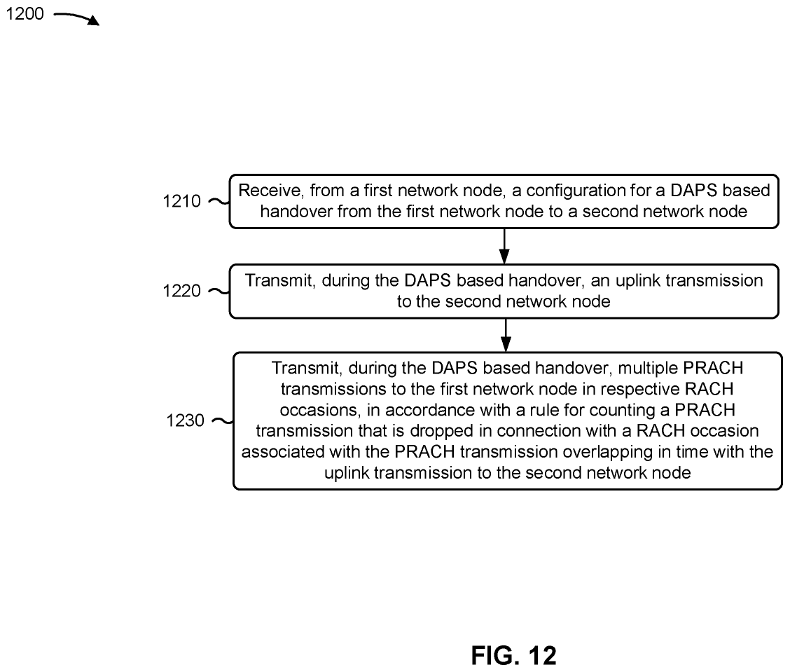

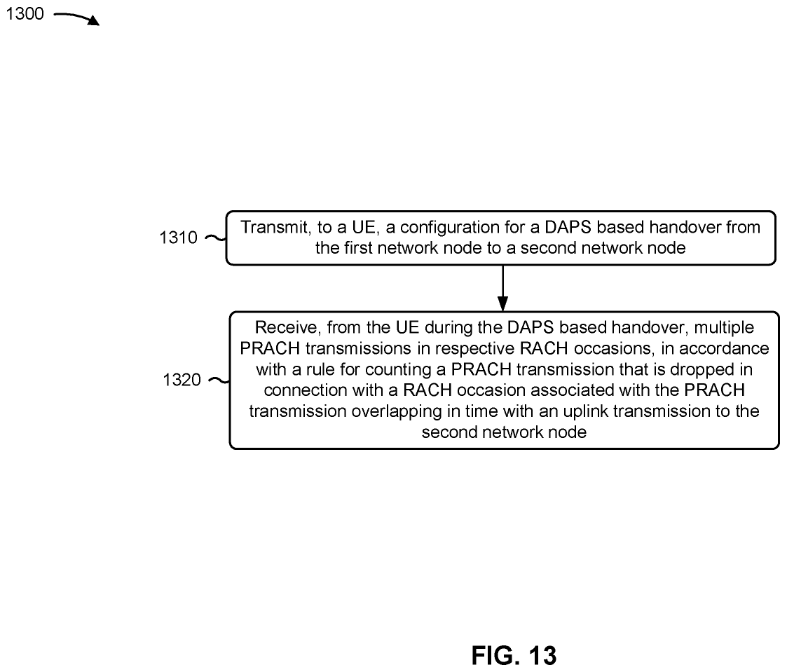

The controller/processor 240 of the network node 110, the controller/processor 280 of the UE 120, and/or any other component(s) of FIG. 2 may perform one or more techniques associated with multiple PRACH transmissions in a random access procedure, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, from a network node, PRACH transmission counting control information (e.g., using antenna 252, modem 254, MIMO detector 256, receive processor 258, controller/processor 280, or memory 282 and/or communication manager 140); and/or means for transmitting, to the network node, multiple PRACH transmissions in a random access procedure in accordance with the PRACH transmission counting control information (e.g., using controller/processor 280, transmit processor 264, TX MIMO processor 266, modem 254, antenna 252, memory 282, and/or communication manager 140). The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a UE (e.g., the UE 120) includes means for receiving, from a network node while operating in a connected state, configuration information that indicates dedicated RACH resources for multiple PRACH transmissions (e.g., using antenna 252, modem 254, MIMO detector 256, receive processor 258, controller/processor 280, or memory 282 and/or communication manager 140); and/or means for transmitting, to the network node, the multiple PRACH transmissions, in a CBRA procedure, using the dedicated RACH resources (e.g., using controller/processor 280, transmit processor 264, TX MIMO processor 266, modem 254, antenna 252, memory 282, and/or communication manager 140). The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a UE (e.g., the UE 120) includes means for receiving, from a first network node, a configuration for a DAPS based handover from the first network node to a second network node (e.g., using antenna 252, modem 254, MIMO detector 256, receive processor 258, controller/processor 280, or memory 282 and/or communication manager 140); means for transmitting, during the DAPS based handover, an uplink transmission to the second network node (e.g., using controller/processor 280, transmit processor 264, TX MIMO processor 266, modem 254, antenna 252, memory 282, and/or communication manager 140); and/or means for transmitting, during the DAPS based handover, multiple PRACH transmissions to the first network node in respective RACH occasions, in accordance with a rule for counting a PRACH transmission that is dropped in connection with a RACH occasion associated with the PRACH transmission overlapping in time with the uplink transmission to the second network node (e.g., using controller/processor 280, transmit processor 264, TX MIMO processor 266, modem 254, antenna 252, memory 282, and/or communication manager 140). The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting PRACH transmission counting control information (e.g., using controller/processor 240, transmit processor 220, TX MIMO processor 230, modem 232, antenna 234, memory 242, scheduler 246, and/or communication manager 150); and/or means for receiving, from a UE, multiple PRACH transmissions in a random access procedure in accordance with the PRACH transmission counting control information (e.g., using antenna 234, modem 232, MIMO detector 236, receive processor 238, controller/processor 240, memory 242, and/or communication manager 150). The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network node (e.g., the network node 110) includes means for transmitting, to a UE while the UE is operating in a connected state, configuration information that indicates dedicated RACH resources for multiple PRACH transmissions (e.g., using controller/processor 240, transmit processor 220, TX MIMO processor 230, modem 232, antenna 234, memory 242, scheduler 246, and/or communication manager 150); and/or means for receiving, from the UE, the multiple PRACH transmissions, in a CBRA procedure, using the dedicated RACH resources (e.g., using antenna 234, modem 232, MIMO detector 236, receive processor 238, controller/processor 240, memory 242, and/or communication manager 150). The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a first network node (e.g., the network node 110) includes means for transmitting, to a UE, a configuration for a DAPS based handover from the first network node to a second network node (e.g., using controller/processor 240, transmit processor 220, TX MIMO processor 230, modem 232, antenna 234, memory 242, scheduler 246, and/or communication manager 150); and/or means for receiving, from the UE during the DAPS based handover, multiple physical random access channel (PRACH) transmissions in respective random access channel (RACH) occasions, in accordance with a rule for counting a PRACH transmission that is dropped in connection with a RACH occasion associated with the PRACH transmission overlapping in time with an uplink transmission to the second network node (e.g., using antenna 234, modem 232, MIMO detector 236, receive processor 238, controller/processor 240, memory 242, and/or communication manager 150). The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

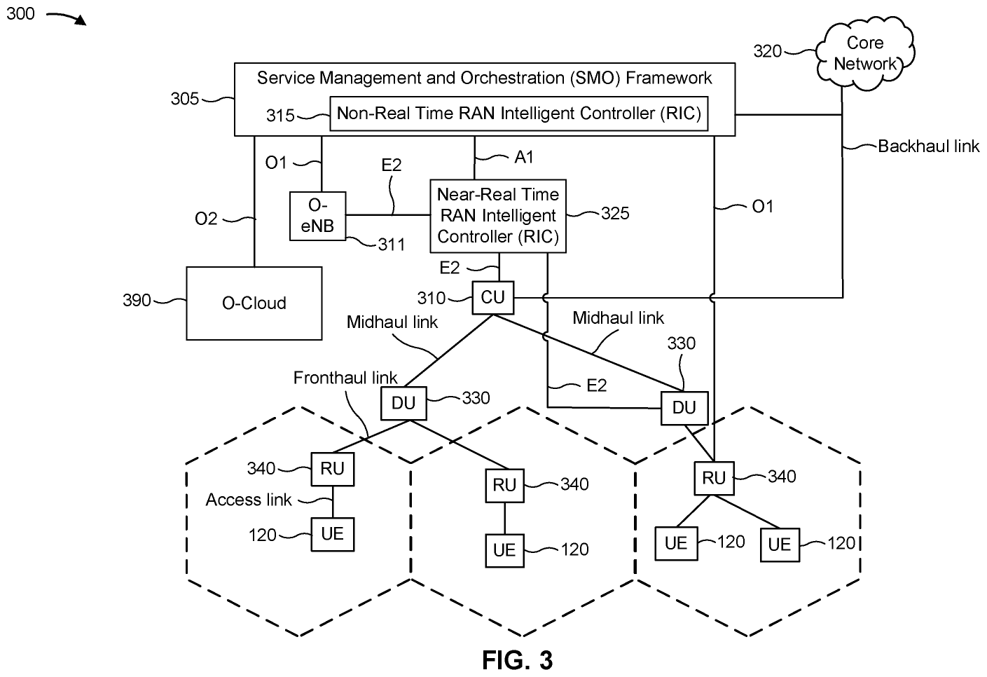

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

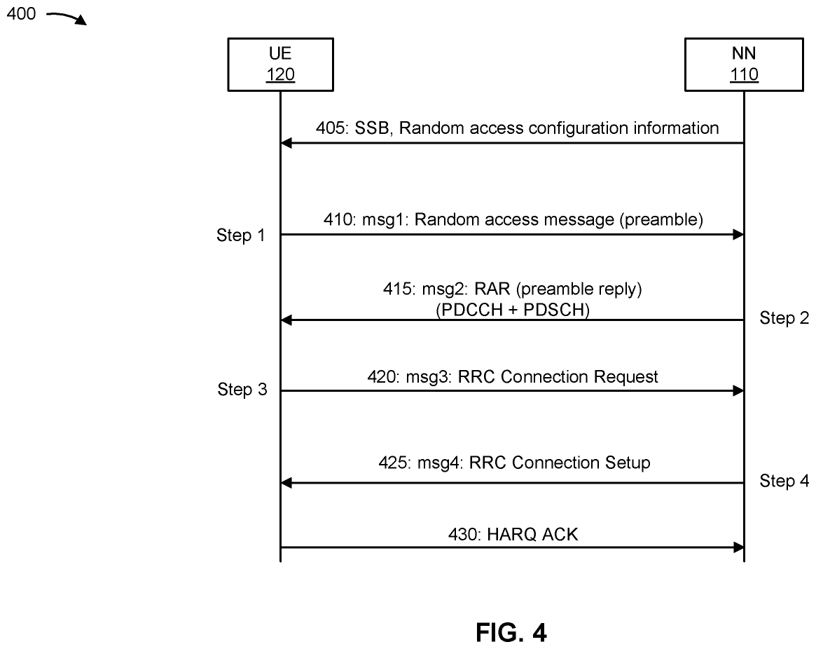

FIG. 4 is a diagram illustrating an example 400 of a four-step random access procedure, in accordance with the present disclosure. As shown in FIG. 4, a network node 110 and a UE 120 may communicate with one another to perform the four-step random access procedure.

As shown by reference number 405, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for CBRA. Additionally, or alternatively, the random access configuration information may be transmitted in an RRC message and/or a physical downlink control channel (PDCCH) order message that triggers a RACH procedure, such as for contention-free random access (CFRA). The random access configuration information may include one or more parameters to be used in the random access procedure, such as one or more parameters for transmitting a random access message (RAM) and/or one or more parameters for receiving a random access response (RAR). In some examples, the network node 110 may transmit multiple SSBs using different beams, and the random access configuration information may indicate a mapping between the SSBs and respective RACH occasions (ROs) for transmitting a RAM. An RO is a PRACH resource (e.g., time and/or frequency resource) for transmitting a PRACH transmission (e.g., the RAM).

As shown by reference number 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier. The transmission of the RAM (e.g., msg1) may be referred to as a PRACH transmission. In some examples, the UE 120 may perform RSRP measurements on multiple SSBs transmitted by the network node 110, and the UE 120 may select an SSB based at least in part on the RSRP measurements. The selected SSB corresponds to a transmit (Tx) beam of the network node 110. The UE may transmit the PRACH transmission (e.g., the RAM) in the PRACH resource (e.g., the RO) that is associated with the selected SSB. The UE may transmit the PRACH transmission (e.g., the RAM) using a spatial filter associated with the selected SSB. The spatial filter corresponds to a Tx beam of the UE 120.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3). In some examples, the network node 110, in connection with receiving the PRACH transmission (e.g., msg1) in a PRACH resource (e.g., the RO) associated with a selected SSB, may transmit the RAR (e.g., msg2) using the beam associated with the selected SSB.

In some aspects, as part of the second step of the four-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request). The UE 120 may transmit the msg3 PUSCH communication (e.g., the RRC connection request) using the same spatial filter as used by the UE 120 to transmit the PRACH transmission (e.g., msg1).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. The network node 110 may transmit msg4 (e.g., the RRC connection setup message) using the same beam as used to transmit msg2 (e.g., the beam associated with the selected SSB). As shown by reference number 430, if the UE 120 successfully receives the RRC connection setup message, the UE 120 may transmit a hybrid automatic repeat request (HARQ) acknowledgment (ACK) (HARQ-ACK).

As indicated above, FIG. 4 is provided as an example. Other examples may differ from what is described with regard to FIG. 4.

In some examples, to enhance PRACH coverage, a UE may be configured to perform multiple PRACH transmissions when initiating a random access channel procedure. For example, the multiple PRACH transmissions may include multiple msg1 repetitions. In some examples, the UE may transmit the multiple PRACH transmissions (e.g., multiple msg1 repetitions) for the 4-step RACH procedure using the same beam. For example, the UE may transmit the multiple PRACH transmissions in respective ROs associated with an SSB of the network node and using the same spatial filter (e.g., corresponding to the same UE Tx beam). In other examples, the UE may transmit the multiple PRACH transmissions (e.g., multiple msg1 repetitions) for the 4-step RACH procedure using different beams. For example, the UE may transmit the multiple PRACH transmissions in ROs associated with an SSB of the network using different spatial filters (e.g., corresponding to UE Tx beams). The multiple PRACH transmissions may provide enhanced PRACH coverage for FR2, but may also be applied to FR1 and/or other frequency bands. Such enhancements for PRACH coverage may be applied for short PRACH formats and/or for other PRACH formats. In some cases, the UE may be configured to perform a particular number of PRACH transmissions in a random access procedure. However, a PRACH transmission may be dropped, for example due to a collision with an SSB of a scheduled downlink reception, or due to dynamic cancellation indication. In cases in which one or more PRACH transmissions are dropped, there may be confusion between the UE and network node as to how the number of PRACH transmissions from the UE is to be counted, which may lead to decreased reliability and increased latency associated with the random access procedure.

Some techniques and apparatuses described herein enable a UE to receive, from a network node, PRACH transmission counting control information. The UE may transmit, to the network node, multiple PRACH transmissions in a random access procedure in accordance with the PRACH transmission counting control information. As a result, based at least in part on the PRACH transmission counting control information, the UE and the network node may each count the multiple PRACH transmissions in the same way in a case when a PRACH transmission is dropped. This increases reliability and decreases latency associated with the random access procedure, and achieves PRACH coverage enhancements associated with the multiple PRACH transmissions.

A random access procedure may be a CBRA procedure or a CFRA procedure. When a UE transitions from an RRC idle state to an RRC connected state, the UE may perform CBRA. When a UE is in the RRC connected state, the UE may be configured to perform CFRA (e.g., in the case of beam failure recovery (BFR)). In this case, if CFRA fails, the UE may initiate CBRA. In some aspects, signaling impacting PRACH transmission counting (e.g., signaling transmitting the PRACH transmission counting control information to the UE) may be different for CBRA (e.g., when the UE is in the RRC idle state or an RRC inactive state) or CFRA (e.g., when the UE is in the RRC connected state). For CFRA, the network node and the UE may have the same understanding of the signaling received by the UE. However, in the case of CBRA, the network node may not know whether the CBRA is initiated by a connected mode UE (e.g., a UE in the RRC connected state) or an idle/inactive mode UE (e.g., a UE in the RRC idle state or the RRC inactive state).

Some techniques and apparatuses described herein enable a UE to receive, from a network node while operating in a connected state, configuration information that indicates dedicated RACH resources for multiple PRACH transmissions. The UE may transmit, to the network node, multiple PRACH transmissions in a CBRA procedure, using the dedicated RACH resources for the multiple PRACH transmissions. As a result, the network node may know that the CBRA procedure is initiated by the UE operating in the connected state. In this way, the network node and the UE may apply the signaling for the PRACH transmission counting control information transmitted to the UE while the UE is in the connected state. Furthermore, the dedicated RACH resources for the connected mode UE may reduce blind detection performed by the network node, and thus reduce latency of the random access procedure.

FIG. 5 is a diagram illustrating an example 500 associated with multiple PRACH transmissions in a random access procedure, in accordance with the present disclosure. As shown in FIG. 5, example 500 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (e.g., from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (e.g., from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown in FIG. 5, and by reference number 505, the network node 110 may transmit, and the UE 120 may receive, PRACH transmission counting control information. In some aspects, the PRACH transmission counting control information may indicate a rule for counting multiple PRACH transmissions to be transmitted by the UE 120 in a random access channel procedure. For example, the PRACH transmission counting control information may indicate a rule for counting the multiple PRACH transmissions in connection with dropping at least one of the multiple PRACH transmissions. “Dropping” a PRACH transmission may refer to refraining from transmitting a PRACH transmission scheduled to be transmitted in an RO. For example, a PRACH transmission may be dropped (e.g., the UE 120 may refrain from transmitting the PRACH transmission) when there is a collision between the PRACH transmission and an SSB transmitted by the network node 110 (e.g., the RO for the PRACH transmission overlaps in time with the SSB), when there is a collision between the PRACH transmission and a scheduled downlink reception for the UE 120 (e.g., the RO for the PRACH transmission overlaps in time with the scheduled downlink reception), or when the UE 120 receives a dynamic cancellation indication cancelling the PRACH transmission, among other examples.

In some aspects, the PRACH transmission counting control information may indicate whether a dropped PRACH transmission is to be counted in a number of PRACH transmissions transmitted by the UE 120. For example, the UE 120 may be configured (e.g., via system information broadcast by the network node 110) to perform a target number

$${N}_{PRACH}^{repeat}$$

of PRACH transmissions. The PRACH transmission counting control information may indicate whether or not a dropped PRACH transmission is to be counted toward the

$${N}_{PRACH}^{repeat}$$

PRACH transmissions. In some aspects, the PRACH transmission counting control information may indicate that a dropped PRACH transmission is to be counted in the number PRACH transmissions transmitted by the UE 120. In this case, the UE 120 may count one or more dropped PRACH transmissions, along with transmitted PRACH transmissions, toward the

$${N}_{PRACH}^{repeat}$$

PRACH transmissions to be performed for a random access procedure. In some other aspects, the PRACH transmission counting control information may indicate that a dropped PRACH transmission is not to be counted in the number of PRACH transmissions transmitted by the UE 120. In this case, one or more dropped transmissions may not be counted toward the

$${N}_{PRACH}^{repeat}$$

PRACH transmissions. That is, in this case, the UE 120 may count only actually transmitted PRACH transmissions toward the

$${N}_{PRACH}^{repeat}$$

PRACH transmissions to be performed by the UE 120.

In some aspects, the PRACH transmission counting control information may include PRACH transmission counting control information that corresponds to one or more reasons for dropping a PRACH transmission. For example, the PRACH transmission counting control information may indicate whether a PRACH transmission that is dropped in connection with a collision with an SSB, a collision with a scheduled downlink reception, or a dynamic cancellation indication is to be counted in the number of PRACH transmissions. Additionally, or alternatively, the PRACH transmission counting control information may indicate a rule for counting a PRACH transmission to a source cell, during a DAPS based handover, that is dropped in connection with a collision between a PRACH transmission and an uplink transmission from the UE 120 to a target cell. For example, the PRACH transmission counting control information may indicate a counting rule that applies for all reasons for dropping a PRACH transmission, different counting rules that apply for different reasons for dropping a PRACH transmission, or a combination thereof.

In some aspects, the network node 110 may include the PRACH transmission counting control information in information that is broadcast by the network node 110. In some aspects, the broadcast PRACH transmission counting control information may be used by the UE 120 for transmitting multiple PRACH transmissions in a CBRA procedure. For example, the UE 120 may perform the CBRA procedure, using the broadcast PRACH transmission counting control information, when the UE 120 is in the RRC idle state (or RRC inactive state) or when the UE 120 is in the RRC connected state (e.g., after CFRA fails). In some aspects, the broadcast PRACH transmission counting control information may also be used by the UE 120 for transmitting PRACH transmissions in a CFRA procedure (e.g., while in the RRC connected state). In some aspects, the PRACH transmission counting control information may be included in a system information block type 1 (SIB1) broadcast by the network node 110. In this case, the system information included in the SIB1 may include the PRACH transmission counting control information. In some aspects, the PRACH transmission counting control information may be included in information that indicates the SSBs actually transmitted by the network node 110 (e.g., in ssb-PositionsInBurst in ServingCellConfigCommon in SIB1). In some aspects, the PRACH transmission counting control information may be included in information that indicates a frame format (e.g., in tdd-UL-DL-ConfigurationCommon). In some aspects, the PRACH transmission counting control information may be included in another field of SIB1 (e.g., in other information carrier in SIB1). In some aspects, the PRACH transmission counting control information may be included in master information included in an SSB broadcast by the network node 110. For example, the PRACH transmission counting control information may be included in information (e.g., master information) that indicates type 0 PDCCH monitoring (e.g., information indicating a control resource set (CORESET) type 0 (CORESET0) for type 0 PDCCH monitoring). In some aspects, the system information and/or master information broadcast by the network node 110 may include other information relating to the multiple PRACH transmissions for a random access procedure, such as a mapping between the SSBs and sets of ROs to be used for the multiple PRACH transmissions and/or the number (e.g., the target number)

$${N}_{PRACH}^{repeat}$$

of transmissions to be transmitted in the random access procedure.

In some aspects, the network node 110 may include PRACH transmission counting control information for a CFRA procedure in UE-specific signaling transmitted from the network node 110 to the UE 120 while the UE 120 is in the RRC connected state. In this case, the UE 120 may use the PRACH transmission counting control information included in the UE-specific signaling for transmitting multiple PRACH transmissions in a CFRA procedure. For example, the PRACH transmission counting control information included in the UE-specific signaling may include UE-specific PRACH transmission counting control information that indicates a UE-specific rule for counting the multiple PRACH transmissions. In some aspects, the PRACH transmission counting control information to be used by the UE 120 for CFRA may be included in UE-specific signaling indicating a dedicated time domain duplex (TDD) configuration (e.g., in tdd-UL-DL-ConfigurationDedicated). In some aspects, the PRACH transmission counting control information to be used by the UE 120 for CFRA may be included in a dynamic cancellation indication received by the UE 120 from the network node 110 (e.g., in ultra-reliable low latency communications (URLLC)). In some aspects, the PRACH transmission counting control information to be used by the UE 120 for CFRA may be included in a dynamic slot formator indicator (SFI) received by the UE 120 from the network node 110.

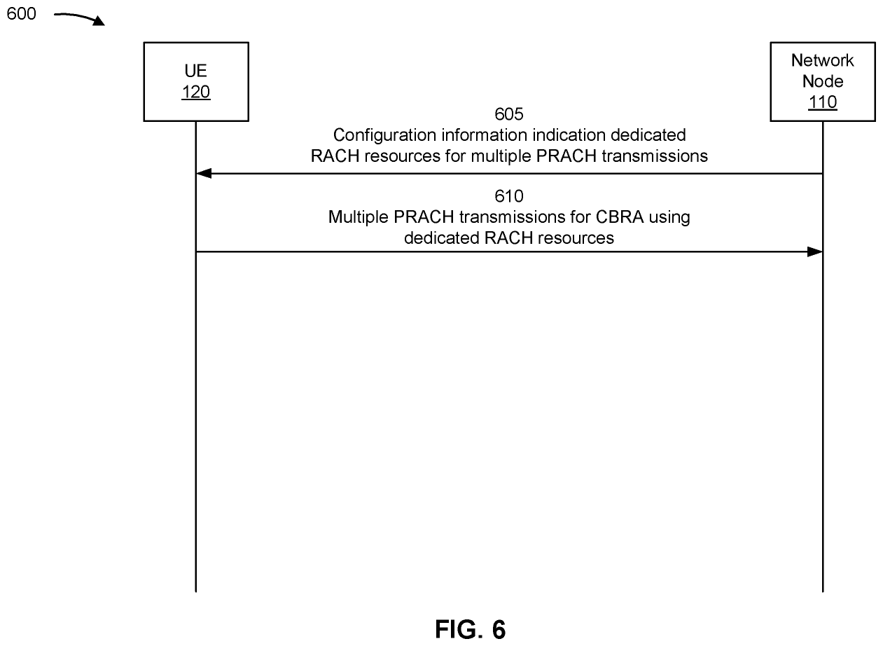

In some aspects, the PRACH transmission counting control information may include first PRACH transmission counting control information broadcast by the network node 110 (e.g., in SIB1 or an SSB) and second PRACH transmission counting control information transmitted by the network node 110 to the UE 120 in UE-specific signaling. In this case, the UE 120 may use the first PRACH transmission counting control information for a CBRA procedure when the UE 120 is in the RRC idle/inactive state, and the UE 120 may use the second PRACH transmission counting control information for a CFRA procedure when the UE 120 is in the RRC connected state. In some aspects, the UE 120 may use the first PRACH transmission counting control information (e.g., the broadcast PRACH transmission counting control information) for a CBRA procedure while the UE 120 is in the RRC connected state (e.g., after CFRA fails). In some other aspects, the UE 120 may use the second PRACH transmission counting control information (e.g., the UE-specific PRACH transmission counting control information) for a CBRA procedure while the UE 120 is in the RRC connected state (e.g., after the CFRA fails). For example, in some aspects, the UE 120 may use the second PRACH transmission counting control information for CBRA, while the UE 120 is in the RRC connected state, together with dedicated resources configured for CBRA while the UE 120 is in the RRC connected state, as described in greater detail in connection with FIG. 6.

As further shown in FIG. 5, and by reference number 510, the UE 120 may transmit, to the network node 110, multiple PRACH transmissions in a random access procedure in accordance with the PRACH counting control information. The network node 110 may receive the multiple PRACH transmissions in accordance with the PRACH transmission counting control information. Transmitting (or receiving) the multiple PRACH transmissions in accordance with the PRACH counting control information refers to transmitting (or receiving) the multiple PRACH transmissions with the number of the multiple PRACH transmissions counted pursuant to the rule for counting the multiple PRACH transmissions (e.g., the rule for whether or not to count dropped PRACH transmissions) indicated in the counting control information. The multiple PRACH transmissions may include multiple transmissions (e.g., repetitions) of msg1 (e.g., including a PRACH preamble) in a 4-step RACH procedure. In some aspects, the UE 120 may transmit the multiple PRACH transmissions on a same beam. For example, the UE 120 may transmit the multiple PRACH transmissions in respective ROs associated with an SSB of the network node 110 using the same spatial Tx filter (e.g., the same UE Tx beam) for each of the multiple PRACH transmissions. In some other aspects, the UE 120 may transmit the multiple PRACH transmissions on different beams. For example, the UE 120 may transmit the multiple PRACH transmissions in respective ROs associated with an SSB of the network node 110 using different spatial Tx filters (e.g., different UE Tx beams).

In some aspects, the random access procedure may be a CBRA procedure. In this case, the UE 120 and the network node 110 may count the multiple PRACH transmissions in accordance with PRACH transmission counting control information broadcast by the network node 110 and received by the UE 120. For example, the UE 120 may transmit the multiple PRACH transmissions in a CBRA procedure, in accordance with the PRACH transmission counting control information, while operating in the idle/inactive state (e.g., the RRC idle/inactive state) or the connected state (e.g., the RRC connected state). In some aspects, the random access procedure may be a CFRA procedure, and the UE 120 may transmit the multiple PRACH transmissions in the CFRA procedure while operating in the connected state (e.g., the RRC connected state). In this case, the UE 120 and the network node 110 may count the multiple PRACH transmissions in accordance with PRACH transmission counting control information transmitted to the UE 120 in UE-specific signaling or PRACH transmission counting control information broadcast by the network node 110 and received by the UE 120.

In some aspects, the UE may drop at least one PRACH transmission in the random access procedure. That is, the UE 120 may refrain from transmitting at least one PRACH transmission (e.g., scheduled to be transmitted in at least one RO) in the random access procedure. For example, the UE 120 may drop (e.g., refrain from transmitting) a PRACH transmission due to a collision between the PRACH transmission and an SSB transmitted by the network node 110, due to a collision between the PRACH transmission and a downlink reception scheduled for the UE 120, or due to receiving a dynamic cancellation indication that indicates cancellation of the RO in which the PRACH transmission is scheduled. The PRACH transmission counting control information may indicate whether the at least one dropped PRACH transmission is to be included in counting the number of PRACH transmissions transmitted to the network node 110. In some aspects, the UE 120 may transmit multiple PRACH transmissions to satisfy the target number

$${N}_{PRACH}^{repeat}$$

of PRACH transmissions. For example

$${N}_{PRACH}^{repeat}$$

may be configured by the network node 110 (e.g., indicated in system information or other signaling) or set in a wireless communication standard (e.g., a 3GPP standard). The PRACH transmission counting control information may indicate whether a dropped PRACH transmission is to be counted in

$${N}_{PRACH}^{repeat}$$

PRACH transmissions performed by the UE 120.

In some aspects, as shown by example 515 in FIG. 5, the PRACH transmission counting control information may indicate that a dropped PRACH is to be included in a count of the number of PRACH transmissions transmitted by the UE 120. Example 515 shows ROs (RO1-RO5) that may be used by the UE 120 to transmit multiple PRACH transmissions. For example, the target number of PRACH transmissions may be

$${N}_{PRACH}^{repeat} = 4.$$

The UE 120 may be scheduled to transmit PRACH transmissions in RO1, RO2, RO3, and RO4, and the UE 120 may drop (e.g., refrain from transmitting) the PRACH transmission scheduled in RO3. As shown in example 515, the UE 120, in accordance with the PRACH transmission counting control information, may count the dropped PRACH transmission in RO3 in the number of PRACH transmissions transmitted by the UE 120. For example, the UE 120 may count a PRACH transmission transmitted in RO1 as a first PRACH transmission (PRACH #0), a PRACH transmission transmitted in RO2 as a second PRACH transmission (PRACH #1), the dropped transmission scheduled (but not transmitted) in RO3 as a third PRACH transmission (PRACH #0), and a PRACH transmission transmitted in RO4 as a fourth PRACH transmission (PRACH #3). In this case, the UE 120 may satisfy the target number of 4 PRACH transmissions without transmitting another PRACH transmission in RO5.

In some aspects, as shown by example 520 in FIG. 5, the PRACH transmission counting control information may indicate that a dropped PRACH is not to be included in a count of the number of PRACH transmissions transmitted by the UE 120. Example 520 shows ROs (RO1-RO5) that may be used by the UE 120 to transmit multiple PRACH transmissions. For example, the target number of PRACH transmissions may be

$${N}_{PRACH}^{repeat} = 4.$$

The UE 120 may be scheduled to transmit PRACH transmissions in RO1, RO2, RO3, and RO4, and the UE 120 may drop (e.g., refrain from transmitting) the PRACH transmission scheduled in RO3. As shown in example 520, the UE 120, in accordance with the PRACH transmission counting control information, may not count the dropped PRACH transmission in RO3 in the number of PRACH transmissions transmitted by the UE 120. In this case, the UE 120 may count only PRACH transmissions that are actually transmitted in the total number of PRACH transmissions. Accordingly, the UE 120 may add a PRACH transmission in another RO (e.g., RO5) when a PRACH transmission is dropped (e.g., in RO3). For example, the UE 120 may count a PRACH transmission transmitted in RO1 as a first PRACH transmission (PRACH #0), a PRACH transmission transmitted in RO2 as a second PRACH transmission (PRACH #1), a PRACH transmission transmitted in RO4 as a third PRACH transmission (PRACH #2), and a PRACH transmission transmitted in RO5 as a fourth PRACH transmission (PRACH #3).

In some aspects, the network node 110 may count the multiple PRACH transmissions from the UE 120 in accordance with the PRACH transmission counting control information. The network node 110 may successfully receive and decode one or more of the PRACH transmissions. In some aspects, the network node 110 may transmit a random access response (e.g., msg2) to the UE 120 based at least in part on receiving one or more of the multiple PRACH transmissions.

In some aspects, as described in greater detail in connection with FIG. 6, in a case in which a random access procedure is a CBRA procedure and the UE 120 is operating in the connected state (e.g., the RRC connected state), the UE 120 may transmit the multiple PRACH transmissions (counted in accordance with the PRACH transmission counting control information) in dedicated RACH resources for the CBRA procedure. In this case, the dedicated RACH resources may be configured for the UE 120 in configuration information received from the network node 110 while the UE is operating in the connected state. In some aspects, in a case in which the PRACH transmission counting control information includes first PRACH transmission counting control information broadcast by the network node 110 and second PRACH transmission counting control information transmitted to the UE 120 in UE-specific signaling while the UE 120 is in the connected state, and the UE 120 transmits the multiple PRACH transmissions for the CBRA procedure in the dedicated RACH resources configured for the UE 120, the UE 120 may count the multiple PRACH transmissions in the CBRA procedure in accordance with the second PRACH transmission counting control information.

As indicated above, FIG. 5 is provided as an example. Other examples may differ from what is described with respect to FIG. 5.

FIG. 6 is a diagram illustrating an example 600 associated with multiple PRACH transmissions in a random access procedure, in accordance with the present disclosure. As shown in FIG. 6, example 600 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (e.g., from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (e.g., from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown in FIG. 6, and by reference number 605, the network node 110 may transmit, to the UE 120, configuration information that indicates dedicated RACH resources for multiple PRACH transmissions. The UE 120 may receive, from the network node 110, the configuration information that indicates the dedicated RACH resources for multiple PRACH transmissions. In some aspects, the network node 110 may transmit the configuration information to the UE 120, and the UE 120 may receive the configuration information, while the UE 120 is operating in the connected state (e.g., the RRC connected state). For example, when the UE 120 is in the connected state, the network node 110 may configure the UE 120 with dedicated RACH resources for performing multiple PRACH transmissions. In some aspects, the dedicated RACH resources configured for the UE 120 may be dedicated RACH resources for performing multiple PRACH transmissions in a CBRA procedure.

In some aspects, the network node 110 may indicate, in the configuration information, UE-specific dedicated RACH resources that customize the multiple PRACH transmissions (e.g., in the CBRA procedure) for the UE 120. In some aspects, the configuration information that indicates the dedicated RACH resources for the UE 120 may be included in an RRC message (or multiple RRC messages). For example, the network node 110 may configure the UE 120 with the dedicated resources for the multiple PRACH transmissions using dedicated RRC resources for indicating the configuration information. In some aspects, the configuration information may also indicate whether the multiple PRACH transmissions are to be transmitted by the UE 120 using the same spatial Tx filter or different spatial Tx filters. In some aspects, the configuration information may indicate a mapping between an SSB and multiple spatial Tx filters (e.g., corresponding to different UE Tx beams) to be used by the UE 120 to transmit the multiple PRACH transmissions associated with the SSB. For example, the configuration information may indicate a respective mapping, for each SSB, between the SSB and a respective set of multiple TX spatial filters to be used by the UE 120 for transmitting the multiple PRACH transmissions. In some aspects, the configuration information may indicate the number (e.g., the target number

$${N}_{PRACH}^{repeat} )$$

of transmissions for the multiple PRACH transmissions and/or a spatial Tx filter configuration to be used for the multiple PRACH transmissions. In some aspects, the number of transmissions and/or the spatial Tx filter configuration indicated in the configuration information may be based at least in part on a use case for the random access procedure (e.g., handover, link failure recovery (LFR), and/or BFR, among other examples). For example, the configuration information may indicate different numbers of transmissions and/or different spatial filter configurations that correspond to different use cases for the random access procedure (e.g., handover, LFD, and/or BFD, among other examples). In some aspects, the configuration information may further include PRACH transmission counting control information that indicates whether a dropped PRACH transmission is to be counted in the number of PRACH transmissions, as described above in connection with FIG. 5. In some aspects, the configuration information may indicate different PRACH transmission counting control information for the different use cases for the random access procedure (e.g., handover, LFD, and/or BFD, among other examples).

As further shown in FIG. 6, and by reference number 610, the UE 120 may transmit, to the network node 110, multiple PRACH transmissions in a CBRA procedure using the dedicated RACH resources. The network node 110 may receive the multiple PRACH transmissions in the dedicated RACH resources. In some aspects, the UE 120 may transmit the multiple PRACH transmissions in the CBRA procedure while operating in the connected state (e.g., the RRC connected state), and the network node 110 may determine that the UE 120 initiated the CBRA procedure while operating in the connected state based at least in part on receiving the multiple PRACH transmissions in the dedicated RACH resources.

In some aspects, the UE 120 may transmit the multiple PRACH transmissions in the dedicated RACH resources using the same spatial Tx filter. In some aspects, the UE 120 may transmit the multiple PRACH transmissions in the dedicated RACH resources using different spatial Tx filters. In some aspects, the UE 120 may transmit the multiple PRACH transmissions using the same spatial Tx filter or different spatial Tx filters based at least in part on an indication, in the configuration information, of whether to use the same spatial Tx filter or different spatial Tx filters. In some aspects, in a case in which the UE 120 transmits the multiple PRACH transmissions using different spatial Tx filters, the UE 120 may transmit each PRACH transmission of the multiple PRACH transmissions using a respective spatial Tx filter of the multiple spatial Tx filters based at least in part on the mapping between an SSB and the multiple spatial transmission filters indicated in the configuration information.

In some aspects, the number of the multiple PRACH transmissions may be based at least in part on a target number of PRACH transmissions indicated in the configuration information. In some aspects, one or more spatial Tx filters used by the UE 120 to transmit the multiple PRACH transmissions may be based at least in part on a spatial Tx filter configuration indicated in the configuration information. In some aspects, the number of the multiple PRACH transmissions and/or the spatial filter configuration used to transmit the multiple PRACH transmissions may be based at least in part on the configuration information and based at least in part on a use case (e.g., handover, LFR, or BFR, among other examples) for which the CBRA procedure is being used.

In some aspects, the number of the multiple PRACH transmissions may be based at least in part on the target number of PRACH transmissions indicated in the configuration information, and PRACH transmission counting control information received by the UE 120 from the network node 110, as described above in connection with FIG. 5. In some aspects, the UE 120 may count the number of PRACH transmissions in the CBRA procedure initiated while the UE 120 is operating in the connected state, in accordance with PRACH transmission counting control information indicated (e.g., in UE-specific signaling) to the UE 120 while the UE 120 is in the connected state. For example, the PRACH transmission counting control information may be included in the configuration information received by the UE 120 while the UE 120 is operating in the connected state. In this case, the network node 110 may determine that the UE 120 is in the connected state in connection with receiving the multiple PRACH transmissions in the CBRA in the dedicated resources, and the network node 110 and the UE 120 may apply the PRACH transmission counting control information signaled to the UE 120 for the CBRA initiated by the UE 120 in the connected state.

In some aspects, by configuring the UE 120 with the dedicated RACH resources for the multiple PRACH transmissions and receiving the multiple PRACH transmissions in the CBRA procedure in the dedicated RACH resources, the amount of blind detection to be performed by the UE 120 on RACH resources may be reduced, which may reduce a RACH latency associated with the CBRA procedure.

As indicated above, FIG. 6 is provided as an example. Other examples may differ from what is described with respect to FIG. 6.

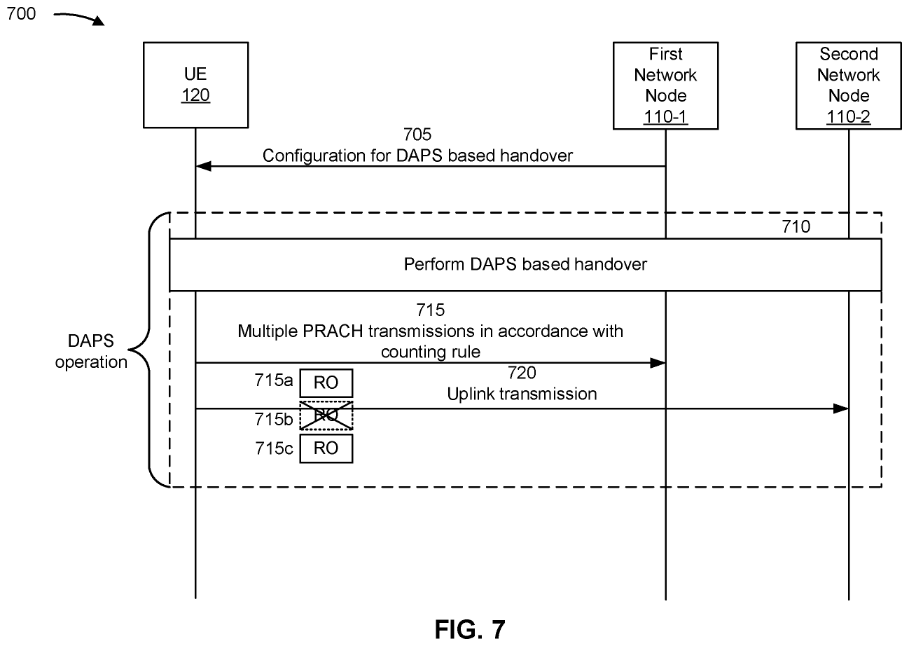

FIG. 7 is a diagram illustrating an example 700 associated with multiple PRACH transmissions in a random access procedure, in accordance with the present disclosure. As shown in FIG. 7, example 700 includes communication between a UE 120, a first network node 110-1, and a second network node 110-2. In some aspects, the UE 120, the first network node 110-1, and the second network node 110-2 may be included in a wireless network, such as wireless network 100. The UE 120 may communicate with the first network node 110-1 and the second network node 110-2 via wireless access links, which may include uplinks and downlinks.

In some aspects, actions described herein as being performed by a network node 110 (e.g., the first network node 110-1 or the second network node 110-2) may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (e.g., from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (e.g., from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown in FIG. 7, and by reference number 705, the first network node 110-1 may transmit, to the UE 120, a configuration for a DAPS based handover from the first network node 110-1 to the second network node 110-2. For example, the first network node 110-1 may be a source network node associated with a source cell, and the second network node 110-2 may be a target network node associated with a target cell. A DAPS based handover is a handover that includes a period of DAPS operation, in which the UE 120 is enabled to simultaneously connect to both source and target cells during the handover. The configuration for the DAPS based handover may be included in an RRC reconfiguration message that indicates the DAPS based handover from the source cell to the target cell. The DAPS based handover may be an intra-frequency handover, an intra-band inter-frequency handover, or an inter-band inter-frequency handover.

As further shown in FIG. 7, and by reference number 710, the UE 120, the first network node 110-1, and the second network node 110-2 may perform the DAPS based handover. In some aspects, the DAPS based handover may include a period of DAPS operation, in which the UE 120 may simultaneously connect with the first network node 110-1 and the second network node 110-2. In some aspects, the DAPS based handover may include, during the period of DAPS operation, communications between the UE 120 and the second network node 110-2 (e.g., during the period of DAPS operation) to establish a connection between the UE 120 and the second network node 110-2. For example, the UE 120, in connection with receiving the configuration of the DAPS based handover, may initiate a random access procedure with the second network node 110-2 to establish a connection with the target cell. The DAPS based handover may also include communications between the first network node 110-1 and the second network node 110-2. In some aspects, during the period of DAPS operation, while the UE 120 is communication with the second network node 110-2 (e.g., the target cell) to establish a connection with the second network node 110-2 and execute the handover from the first network node 110-1 to the second network node 110-2, the UE 120 may also continue receiving data from and/or transmitting data to the first network node 110-1 (e.g., the source cell).

As further shown in FIG. 7, and by reference number 715, during the DAPS based handover (e.g., during the period of DAPS operation), the UE 120 may transmit multiple PRACH transmissions in a random access procedure to the first network node 110-1. For example, the UE 120 may transmit the multiple PRACH transmissions to a source master cell group (MCG) associated with the first network node 110-1. The random access procedure may be a CFRA procedure (e.g., for LFR or BFR) or a CBRA (e.g., after CFRA fails). The multiple PRACH transmissions may be scheduled in respective ROs (e.g., 715a, 715b, and 715c).

As shown by reference number 720, during the DAPS based handover, the UE 120 may transmit an uplink transmission to the second network node 110-2. For example, the UE 120 may transmit the uplink transmission on a target MCG associated with the second network node 110-2. The uplink transmission may be an uplink communication that is part of the procedure for establishing the connection with the second network node 110-2 and/or executing the handover from the first network node 110-1 to the second network node 110-2. In some aspects, the uplink transmission to the second network node 110-2 may be a physical uplink control channel (PUCCH) transmission, a PUSCH transmission, a sounding reference signal (SRS) transmission, a PRACH transmission, or a msg3 PUSCH transmission.

In some aspects, an RO (e.g., RO 715b) for a PRACH transmission to the first network node 110-1 may overlap in time with the uplink transmission to the second network node 110-2 during the DAPS based handover. In this case, the UE 120 may refrain from transmitting (e.g., the UE 120 may drop) the PRACH transmission in the RO (e.g., RO 715b) that overlaps in time with the uplink transmission to the second network node 110-2. For DAPS operation in a same frequency band, the PRACH transmission to the source MCG may be cancelled if the PRACH transmission to the source MCG overlaps with the uplink transmission to the target MCG. For example, for DAPS operation in a same frequency band, the UE 120 may not transmit PRACH on the source MCG in a slot overlapping in time with an uplink transmission (e.g., a PUSCH, PUCCH, or SRS transmission) on the target MCG, or when a gap between the first or last symbol of the uplink transmission (e.g., the PUSCH, PUCCH, or SRS transmission) on the target MCG is separated by less than N symbols from a last or first symbol, respectively, of a PRACH transmission on the source MCG. In this case, N may be based at least in part on a subcarrier spacing (SCS).

In some aspects, the UE 120 may transmit the multiple PRACH transmissions to the first network node 110-1 in accordance with a counting rule. In some aspects, the counting rule may be a rule for counting a PRACH transmission that is dropped in connection with a RACH occasion associated with the PRACH transmission overlapping in time with an uplink transmission to the second network node 110-2. In some aspects, the number of PRACH transmissions to be transmitted to the first network node 110-1 in the random access procedure may be a target number

$${N}_{PRACH}^{repeat}$$

of PRACH transmissions (e.g., PRACH transmissions transmitted over

$${N}_{PRACH}^{repeat}$$

ROs). In some aspects, the counting rule may be a rule for whether or not the PRACH transmission that is dropped in connection with the PRACH transmission overlapping in time with the uplink communication to the second network node 110-2 is to be counted toward the target number

$${N}_{PRACH}^{repeat}$$

of PRACH transmissions. For example, the rule may be a rule for whether the RO (e.g., RO 715b) that overlaps in time with the uplink communication to the second network node 110-2 is to be counted in the

$${N}_{PRACH}^{repeat}$$

ROs over which the multiple PRACH transmissions are to be transmitted.

In some aspects, the counting rule may indicate or specify that the UE 120 is to count the dropped PRACH transmission (e.g., the PRACH transmission dropped in connection with the RO associated with the PRACH transmission overlapping in time with the uplink transmission to the second network node 110-2) in the

$${N}_{PRACH}^{repeat}$$

PRACH transmissions (e.g., the UE 120 is to count the RO associated with the dropped PRACH in the

$${N}_{PRACH}^{repeat}$$

ROs over which the multiple PRACH transmissions are to be transmitted). In this case, the UE 120, in accordance with the counting rule, may count the dropped PRACH transmission in the target number

$${N}_{PRACH}^{repeat}$$

of PRACH transmissions.

In some aspects, the counting rule may indicate or specify that the UE 120 is to not count the dropped PRACH transmission (e.g., the PRACH transmission dropped in connection with the RO associated with the PRACH transmission overlapping in time with the uplink transmission to the second network node 110-2) in the

$${N}_{PRACH}^{repeat}$$

PRACH transmissions (e.g., the UE 120 is to not count the RO associated with the dropped PRACH in the

$${N}_{PRACH}^{repeat}$$

ROs over which the multiple PRACH transmissions are to be transmitted). In this case, the UE 120, in accordance with the counting rule, may not count the dropped PRACH transmission in the target number

$${N}_{PRACH}^{repeat}$$

of PRACH transmissions.

In some aspects, the counting rule may be a counting rule that is specific for DAPS based handovers. In some aspects, the counting rule for the DAPS handovers may be included with a rule for counting dropped PRACH transmissions in other scenarios. In some aspects, the counting rule for the DAPS based handovers may be specified in a wireless communication standard (e.g., a 3GPP standard). In some aspects, the counting rule for the DAPS based handovers may be indicated to the UE 120 by a network node (e.g., the first network node 110-1), for example in the PRACH transmission counting control information described above in connection with FIG. 5 and/or the configuration information described above in connection with FIG. 6.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with multiple physical random access channel transmissions in a random access procedure.

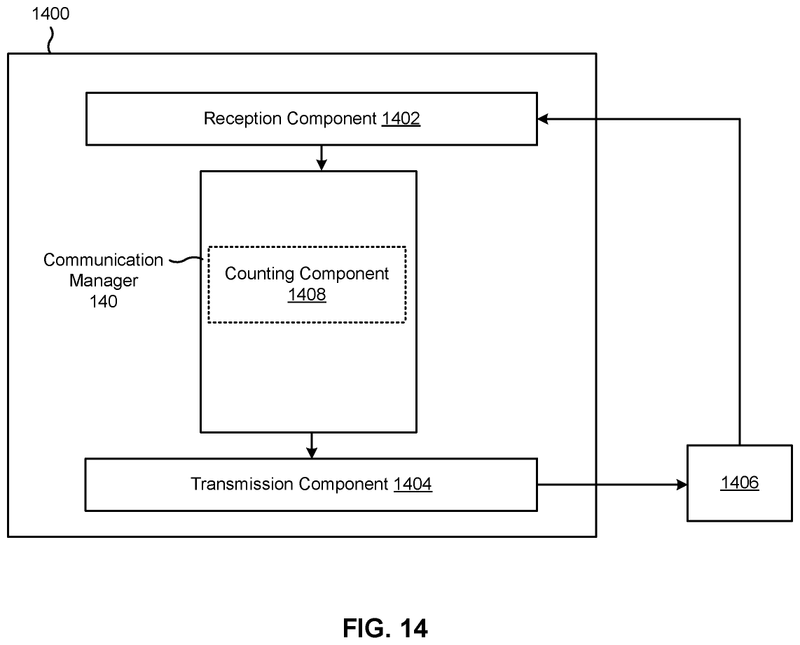

As shown in FIG. 8, in some aspects, process 800 may include receiving, from a network node, PRACH transmission counting control information (block 810). For example, the UE (e.g., using communication manager 140 and/or reception component 1402, depicted in FIG. 14) may receive, from a network node, PRACH transmission counting control information, as described above, for example with reference to FIG. 5.

As further shown in FIG. 8, in some aspects, process 800 may include transmitting, to the network node, multiple PRACH transmissions in a random access procedure in accordance with the PRACH transmission counting control information (block 820). For example, the UE (e.g., using communication manager 140 and/or transmission component 1404, depicted in FIG. 14) may transmit, to the network node, multiple PRACH transmissions in a random access procedure in accordance with the PRACH transmission counting control information, as described above, for example with reference to FIG. 5.

Process 800 may include additional aspects, such as any single aspect or any combination of aspects described below and/or in connection with one or more other processes described elsewhere herein.

In a first aspect, the PRACH transmission counting control information indicates a rule for counting the multiple PRACH transmissions in connection with dropping at least one of the multiple PRACH transmissions.

In a second aspect, alone or in combination with the first aspect, the PRACH transmission counting control information is included in a SIB1.

In a third aspect, alone or in combination with one or more of the first and second aspects, the PRACH transmission counting control information is included in information that indicates SSBs transmitted by the network node.

In a fourth aspect, alone or in combination with one or more of the first through third aspects, the PRACH transmission counting control information is included in information that indicates a frame format.

In a fifth aspect, alone or in combination with one or more of the first through fourth aspects, the PRACH transmission counting control information is included in master information in an SSB.

In a sixth aspect, alone or in combination with one or more of the first through fifth aspects, the PRACH transmission counting control information is included in information that indicates type 0 PDCCH monitoring.

In a seventh aspect, alone or in combination with one or more of the first through sixth aspects, the random access procedure is a CFRA procedure, and the PRACH transmission counting control information is included in UE-specific signaling.

In an eighth aspect, alone or in combination with one or more of the first through seventh aspects, the random access procedure is a CFRA procedure, and the PRACH transmission counting control information is included in a dynamic cancellation indication.

In a ninth aspect, alone or in combination with one or more of the first through eighth aspects, the random access procedure is a CFRA procedure, and the PRACH transmission counting control information is included in a dynamic SFI.

In a tenth aspect, alone or in combination with one or more of the first through ninth aspects, the multiple PRACH transmissions include a number of PRACH transmissions, and the PRACH counting control information indicates whether a dropped PRACH transmission is to be counted in the number of PRACH transmissions.

In an eleventh aspect, alone or in combination with one or more of the first through tenth aspects, the PRACH counting control information indicates that the dropped PRACH transmission is to be counted in the number of PRACH transmissions.

In a twelfth aspect, alone or in combination with one or more of the first through eleventh aspects, the PRACH counting control information indicates that the dropped PRACH transmission is not to be counted in the number of PRACH transmissions.

In a thirteenth aspect, alone or in combination with one or more of the first through twelfth aspects, the multiple PRACH transmissions include a number of PRACH transmissions, and the PRACH counting control information indicates whether a PRACH transmission that is dropped in connection with a collision with an SSB, a collision with a scheduled downlink reception, or a dynamic cancellation indication is to be counted in the number of PRACH transmissions.

In a fourteenth aspect, alone or in combination with one or more of the first through thirteenth aspects, process 800 includes receiving, from the network node while operating in a connected state, configuration information that indicates dedicated RACH resources for the multiple PRACH transmissions in a CBRA procedure, wherein transmitting the multiple PRACH transmissions includes transmitting the multiple PRACH transmissions, in a CBRA procedure, using the dedicated RACH resources.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with multiple PRACH transmissions in a random access procedure.

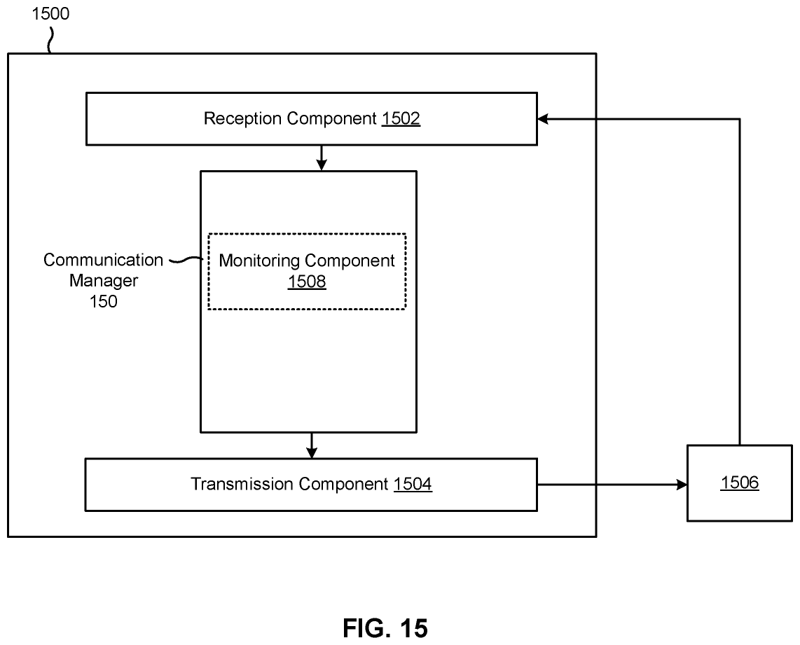

As shown in FIG. 9, in some aspects, process 900 may include transmitting PRACH transmission counting control information (block 910). For example, the network node (e.g., using communication manager 150 and/or transmission component 1504, depicted in FIG. 15) may transmit PRACH transmission counting control information, as described above, for example with reference to FIG. 5.

As further shown in FIG. 9, in some aspects, process 900 may include receiving, from a UE, multiple PRACH transmissions in a random access procedure in accordance with the PRACH transmission counting control information (block 920). For example, the network node (e.g., using communication manager 150 and/or reception component 1502, depicted in FIG. 15) may receive, from a UE, multiple PRACH transmissions in a random access procedure in accordance with the PRACH transmission counting control information, as described above, for example with reference to FIG. 5.

Process 900 may include additional aspects, such as any single aspect or any combination of aspects described below and/or in connection with one or more other processes described elsewhere herein.

In a first aspect, the PRACH transmission counting control information indicates a rule for counting the multiple PRACH transmissions in connection with dropping at least one of the multiple PRACH transmissions.

In a second aspect, alone or in combination with the first aspect, the PRACH transmission counting control information is included in a SIB1.

In a third aspect, alone or in combination with one or more of the first and second aspects, the PRACH transmission counting control information is included in information that indicates SSBs transmitted by the network node.

In a fourth aspect, alone or in combination with one or more of the first through third aspects, the PRACH transmission counting control information is included in information that indicates a frame format.

In a fifth aspect, alone or in combination with one or more of the first through fourth aspects, the PRACH transmission counting control information is included in master information in an SSB.

In a sixth aspect, alone or in combination with one or more of the first through fifth aspects, the PRACH transmission counting control information is included in information that indicates type 0 PDCCH monitoring.

In a seventh aspect, alone or in combination with one or more of the first through sixth aspects, the random access procedure is a CFRA procedure, and the PRACH transmission counting control information is included in UE-specific signaling.

In an eighth aspect, alone or in combination with one or more of the first through seventh aspects, the random access procedure is a CFRA procedure, and the PRACH transmission counting control information is included in a dynamic cancellation indication.

In a ninth aspect, alone or in combination with one or more of the first through eighth aspects, the random access procedure is a CFRA procedure, and the PRACH transmission counting control information is included in a dynamic SFI.

In a tenth aspect, alone or in combination with one or more of the first through ninth aspects, the multiple PRACH transmissions include a number of PRACH transmissions, and the PRACH counting control information indicates whether a dropped PRACH transmission is to be counted in the number of PRACH transmissions.

In an eleventh aspect, alone or in combination with one or more of the first through tenth aspects, the PRACH counting control information indicates that the dropped PRACH transmission is to be counted in the number of PRACH transmissions.

In a twelfth aspect, alone or in combination with one or more of the first through eleventh aspects, the PRACH counting control information indicates that the dropped PRACH transmission is not to be counted in the number of PRACH transmissions.

In a thirteenth aspect, alone or in combination with one or more of the first through twelfth aspects, the multiple PRACH transmissions include a number of PRACH transmissions, and the PRACH counting control information indicates whether a PRACH transmission that is dropped in connection with a collision with an SSB, a collision with a scheduled downlink reception, or a dynamic cancellation indication is to be counted in the number of PRACH transmissions.

In a fourteenth aspect, alone or in combination with one or more of the first through thirteenth aspects, process 900 includes transmitting, to the UE while the UE operating in a connected state, configuration information that indicates dedicated RACH resources for the multiple PRACH transmissions in a CBRA procedure, wherein receiving the multiple PRACH transmissions includes receiving the multiple PRACH transmissions, in a CBRA procedure, using the dedicated RACH resources.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with multiple PRACH transmissions in a random access procedure.

As shown in FIG. 10, in some aspects, process 1000 may include receiving, from a network node while operating in a connected state, configuration information that indicates dedicated RACH resources for multiple PRACH transmissions (block 1010). For example, the UE (e.g., using communication manager 140 and/or reception component 1402, depicted in FIG. 14) may receive, from a network node while operating in a connected state, configuration information that indicates dedicated RACH resources for multiple PRACH transmissions, as described above, for example with reference to FIG. 6.

As further shown in FIG. 10, in some aspects, process 1000 may include transmitting, to the network node, the multiple PRACH transmissions, in a CBRA procedure, using the dedicated RACH resources (block 1020). For example, the UE (e.g., using communication manager 140 and/or transmission component 1404, depicted in FIG. 14) may transmit, to the network node, the multiple PRACH transmissions, in a CBRA procedure, using the dedicated RACH resources, as described above, for example with reference to FIG. 6.

Process 1000 may include additional aspects, such as any single aspect or any combination of aspects described below and/or in connection with one or more other processes described elsewhere herein.

In a first aspect, the configuration information indicates whether to transmit the multiple PRACH transmissions using a same spatial transmission filter or different spatial transmission filters, and transmitting the multiple PRACH transmissions includes transmitting the multiple PRACH transmissions using the same spatial transmission filter or different spatial transmission filters based at least in part on the configuration information.

In a second aspect, alone or in combination with the first aspect, the configuration information indicates a mapping between an SSB and multiple spatial transmission filters, and transmitting the multiple PRACH transmissions includes transmitting each PRACH transmission of the multiple PRACH transmissions using a respective spatial transmission filter of the multiple spatial transmission filters based at least in part on the mapping between the SSB and the multiple spatial transmission filters.

In a third aspect, alone or in combination with one or more of the first and second aspects, the configuration information indicates a number of the multiple PRACH transmissions.

In a fourth aspect, alone or in combination with one or more of the first through third aspects, the configuration information indicates a spatial transmission filter configuration for the multiple PRACH transmissions.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with multiple PRACH transmissions in a random access procedure.

As shown in FIG. 11, in some aspects, process 1100 may include transmitting, to a UE while the UE is operating in a connected state, configuration information that indicates dedicated RACH resources for multiple PRACH transmissions (block 1110). For example, the network node (e.g., using communication manager 150 and/or transmission component 1504, depicted in FIG. 15) may transmit, to a UE while the UE is operating in a connected state, configuration information that indicates dedicated RACH resources for multiple PRACH transmissions, as described above, for example with reference to FIG. 6.

As further shown in FIG. 11, in some aspects, process 1100 may include receiving, from the UE, the multiple PRACH transmissions, in a CBRA procedure, using the dedicated RACH resources (block 1120). For example, the network node (e.g., using communication manager 150 and/or reception component 1502, depicted in FIG. 15) may receive, from the UE, the multiple PRACH transmissions, in a CBRA procedure, using the dedicated RACH resources, as described above, for example with reference to FIG. 6.

Process 1100 may include additional aspects, such as any single aspect or any combination of aspects described below and/or in connection with one or more other processes described elsewhere herein.

In a first aspect, the configuration information indicates whether the UE is to transmit the multiple PRACH transmissions using a same spatial transmission filter or different spatial transmission filters.

In a second aspect, alone or in combination with the first aspect, the configuration information indicates a mapping between an SSB and multiple spatial transmission filters.

In a third aspect, alone or in combination with one or more of the first and second aspects, the configuration information indicates a number of the multiple PRACH transmissions.

In a fourth aspect, alone or in combination with one or more of the first through third aspects, the configuration information indicates a spatial transmission filter configuration for the multiple PRACH transmissions.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120) performs operations associated with multiple PRACH transmissions in a random access procedure.

As shown in FIG. 12, in some aspects, process 1200 may include receiving, from a first network node, a configuration for a DAPS based handover from the first network node to a second network node (block 1210). For example, the UE (e.g., using communication manager 140 and/or reception component 1402, depicted in FIG. 14) may receive, from a first network node, a configuration for a DAPS based handover from the first network node to a second network node, as described above, for example, with reference to FIG. 7.

As further shown in FIG. 12, in some aspects, process 1200 may include transmitting, during the DAPS based handover, an uplink transmission to the second network node (block 1220). For example, the UE (e.g., using communication manager 140 and/or transmission component 1404, depicted in FIG. 14) may transmit, during the DAPS based handover, an uplink transmission to the second network node, as described above, for example, with reference to FIG. 7.

As further shown in FIG. 12, in some aspects, process 1200 may include transmitting, during the DAPS based handover, multiple PRACH transmissions to the first network node in respective RACH occasions, in accordance with a rule for counting a PRACH transmission that is dropped in connection with a RACH occasion associated with the PRACH transmission overlapping in time with the uplink transmission to the second network node (block 1230). For example, the UE (e.g., using communication manager 140 and/or transmission component 1404, depicted in FIG. 14) may transmit, during the DAPS based handover, multiple PRACH transmissions to the first network node in respective RACH occasions, in accordance with a rule for counting a PRACH transmission that is dropped in connection with a RACH occasion associated with the PRACH transmission overlapping in time with the uplink transmission to the second network node, as described above, for example, with reference to FIG. 7.

Process 1200 may include additional aspects, such as any single aspect or any combination of aspects described below and/or in connection with one or more other processes described elsewhere herein.

In a first aspect, transmitting the multiple PRACH transmissions to the first network node in respective RACH occasions in accordance with the rule includes transmitting the multiple PRACH transmissions to the first network node to satisfy a target number of PRACH transmissions, wherein the PRACH transmission that is dropped in connection with the RACH occasion associated with the PRACH transmission overlapping in time with the uplink transmission to the second network node is counted in the target number of PRACH transmissions.

In a second aspect, alone or in combination with the first aspect, transmitting the multiple PRACH transmissions to the first network node in respective RACH occasions in accordance with the rule includes transmitting the multiple PRACH transmissions to the first network node to satisfy a target number of PRACH transmissions, wherein the PRACH transmission that is dropped in connection with the RACH occasion associated with the PRACH transmission overlapping in time with the uplink transmission to the second network node is not counted in the target number of PRACH transmissions.

In a third aspect, alone or in combination with one or more of the first and second aspects, the uplink transmission to the second network node includes at least one of a PUCCH transmission, a PUSCH transmission, an SRS, a PRACH transmission, or a Msg3 PUSCH transmission.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a first network node, in accordance with the present disclosure. Example process 1300 is an example where the first network node (e.g., network node 110 and/or first network node 110-1) performs operations associated with multiple physical random access channel transmissions in a random access procedure.

As shown in FIG. 13, in some aspects, process 1300 may include transmitting, to a UE, a configuration for a DAPS based handover from the first network node to a second network node (block 1310). For example, the first network node (e.g., using communication manager 150 and/or transmission component 1504, depicted in FIG. 15) may transmit, to a UE, a configuration for a DAPS based handover from the first network node to a second network node, as described above, for example, with reference to FIG. 7.

As further shown in FIG. 13, in some aspects, process 1300 may include receiving, from the UE during the DAPS based handover, multiple PRACH transmissions in respective RACH occasions, in accordance with a rule for counting a PRACH transmission that is dropped in connection with a RACH occasion associated with the PRACH transmission overlapping in time with an uplink transmission to the second network node (block 1320). For example, the first network node (e.g., using communication manager 150 and/or reception component 1502, depicted in FIG. 15) may receive, from the UE during the DAPS based handover, multiple PRACH transmissions in respective RACH occasions, in accordance with a rule for counting a PRACH transmission that is dropped in connection with a RACH occasion associated with the PRACH transmission overlapping in time with an uplink transmission to the second network node, as described above, for example, with reference to FIG. 7.

Process 1300 may include additional aspects, such as any single aspect or any combination of aspects described below and/or in connection with one or more other processes described elsewhere herein.

In a first aspect, receiving the multiple PRACH transmissions to the first network node in respective RACH occasions in accordance with the rule includes receiving the multiple PRACH transmissions, wherein the PRACH transmission that is dropped in connection with the RACH occasion associated with the PRACH transmission overlapping in time with the uplink transmission to the second network node is counted in a target number of PRACH transmissions.

In a second aspect, alone or in combination with the first aspect, receiving the multiple PRACH transmissions to the first network node in respective RACH occasions in accordance with the rule includes receiving the multiple PRACH transmissions to the first network node, wherein the PRACH transmission that is dropped in connection with the RACH occasion associated with the PRACH transmission overlapping in time with the uplink transmission to the second network node is not counted in a target number of PRACH transmissions.

In a third aspect, alone or in combination with one or more of the first and second aspects, the uplink transmission to the second network node includes at least one of a PUCCH transmission, a PUSCH transmission, an SRS, a PRACH transmission, or a Msg3 PUSCH transmission.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include a counting component 1408, among other examples.

In some aspects, the apparatus 1400 may be configured to perform one or more operations described herein in connection with FIGS. 5-7. Additionally, or alternatively, the apparatus 1400 may be configured to perform one or more processes described herein, such as process 800 of FIG. 8, process 1000 of FIG. 10, process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

In some aspects, the reception component 1402 may receive, from a network node, PRACH transmission counting control information. The transmission component 1404 may transmit, to the network node, multiple PRACH transmissions in a random access procedure in accordance with the PRACH transmission counting control information.

The counting component 1408 may count a number of the multiple PRACH transmissions in the random access procedure in accordance with the PRACH transmission counting control information.

In some aspects, the reception component 1402 may receive from a network node, while operating in a connected state, configuration information that indicates dedicated RACH resources for multiple PRACH transmissions. The transmission component 1404 may transmit, to the network node, the multiple PRACH transmissions, in a CBRA procedure, using the dedicated RACH resources.

In some aspects, the reception component 1402 may receive, from a first network node, a configuration for a DAPS based handover from the first network node to a second network node. The transmission component 1404, may transmit, during the DAPS based handover, an uplink transmission to the second network node. The transmission component 1404, may transmit during the DAPS based handover, multiple PRACH transmissions to the first network node in respective RACH occasions, in accordance with a rule for counting a PRACH transmission that is dropped in connection with a RACH occasion associated with the PRACH transmission overlapping in time with the uplink transmission to the second network node.

The counting component 1408 may count a number of the multiple PRACH transmissions to the first network node in accordance with the rule for counting a PRACH transmission that is dropped in connection with a RACH occasion associated with the PRACH transmission overlapping in time with the uplink transmission to the second network node.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include a monitoring component 1508, among other examples.

In some aspects, the apparatus 1500 may be configured to perform one or more operations described herein in connection with FIGS. 5-7. Additionally, or alternatively, the apparatus 1500 may be configured to perform one or more processes described herein, such as process 900 of FIG. 9, process 1100 of FIG. 11, process 1300 of FIG. 13, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

In some aspects, the transmission component 1504 may transmit PRACH transmission counting control information. The reception component 1502 may receive, from a UE, multiple PRACH transmissions in a random access procedure in accordance with the PRACH transmission counting control information.

In some aspects, the transmission component 1504 may transmit, to a UE while the UE is operating in a connected state, configuration information that indicates dedicated RACH resources for multiple PRACH transmissions. The reception component 1502 may receive, from the UE, the multiple PRACH transmissions, in a CBRA procedure, using the dedicated RACH resources.

The monitoring component 1508 may monitor the dedicated RACH resources for the multiple PRACH transmissions.

In some aspects, the transmission component 1504 may transmit, to a UE, a configuration for a DAPS based handover from the first network node to a second network node. The reception component 1502 may receive, from the UE during the DAPS based handover, multiple PRACH transmissions in respective RACH occasions, in accordance with a rule for counting a PRACH transmission that is dropped in connection with a RACH occasion associated with the PRACH transmission overlapping in time with an uplink transmission to the second network node.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by an apparatus of a user equipment (UE), comprising: receiving, from a network node, physical random access channel (PRACH) transmission counting control information; and transmitting, to the network node, multiple PRACH transmissions in a random access procedure in accordance with the PRACH transmission counting control information.

Aspect 2: The method of Aspect 1, wherein the PRACH transmission counting control information indicates a rule for counting the multiple PRACH transmissions in connection with dropping at least one of the multiple PRACH transmissions.

Aspect 3: The method of any of Aspects 1-2, wherein the PRACH transmission counting control information is included in a system information block type 1 (SIB1).

Aspect 4: The method of any of Aspects 1-3, wherein the PRACH transmission counting control information is included in information that indicates synchronization signal blocks (SSBs) transmitted by the network node.

Aspect 5: The method of any of Aspects 1-3, wherein the PRACH transmission counting control information is included in information that indicates a frame format.

Aspect 6: The method of any of Aspects 1-2, wherein the PRACH transmission counting control information is included in master information in a synchronization signal block (SSB).

Aspect 7: The method of any of Aspects 1-2 and 6, wherein the PRACH transmission counting control information is included in information that indicates type 0 physical downlink control channel (PDCCH) monitoring.

Aspect 8: The method of any of Aspects 1-7, wherein the random access procedure is a contention free random access (CFRA) procedure, and wherein the PRACH transmission counting control information is included in UE-specific signaling.

Aspect 9: The method of any of Aspects 1-8, wherein the random access procedure is a contention free random access (CFRA) procedure, and wherein the PRACH transmission counting control information is included in a dynamic cancellation indication.

Aspect 10: The method of any of Aspects 1-8, wherein the random access procedure is a contention free random access (CFRA) procedure, and wherein the PRACH transmission counting control information is included in a dynamic slot format indicator (SFI).

Aspect 11: The method of any of Aspects 1-10, wherein the multiple PRACH transmissions include a number of PRACH transmissions, and wherein the PRACH counting control information indicates whether a dropped PRACH transmission is to be counted in the number of PRACH transmissions.

Aspect 12: The method of Aspect 11, wherein the PRACH counting control information indicates that the dropped PRACH transmission is to be counted in the number of PRACH transmissions.

Aspect 13: The method of Aspect 11, wherein the PRACH counting control information indicates that the dropped PRACH transmission is not to be counted in the number of PRACH transmissions.

Aspect 14: The method of any of Aspects 1-13, wherein the multiple PRACH transmissions include a number of PRACH transmissions, and wherein the PRACH counting control information indicates whether a PRACH transmission that is dropped in connection with a collision with a synchronization signal block (SSB), a collision with a scheduled downlink reception, or a dynamic cancellation indication is to be counted in the number of PRACH transmissions.

Aspect 15: The method of any of Aspects 1-14, wherein the multiple PRACH transmissions include a number of PRACH transmissions to a source cell in a dual active protocol stack (DAPS) based handover, and wherein the PRACH counting control information indicates whether a PRACH transmission that is dropped in connection with a random access channel (RACH) occasion associated with the PRACH transmission overlapping in time with an uplink communication to a target cell is to be counted in the number of PRACH transmissions.

Aspect 16: A method of wireless communication performed by an apparatus of a network node, comprising: transmitting physical random access channel (PRACH) transmission counting control information; and receiving, from a user equipment (UE), multiple PRACH transmissions in a random access procedure in accordance with the PRACH transmission counting control information.

Aspect 17: The method of Aspect 16, wherein the PRACH transmission counting control information indicates a rule for counting the multiple PRACH transmissions in connection with dropping at least one of the multiple PRACH transmissions.

Aspect 18: The method of any of Aspects 16-17, wherein the PRACH transmission counting control information is included in a system information block type 1 (SIB1).

Aspect 19: The method of any of Aspects 16-18, wherein the PRACH transmission counting control information is included in information that indicates synchronization signal blocks (SSBs) transmitted by the network node.

Aspect 20: The method of any of Aspects 16-18, wherein the PRACH transmission counting control information is included in information that indicates a frame format.

Aspect 21: The method of any of Aspects 16-17, wherein the PRACH transmission counting control information is included in master information in a synchronization signal block (SSB).

Aspect 22: The method of any of Aspects 16-17 and 21, wherein the PRACH transmission counting control information is included in information that indicates type 0 physical downlink control channel (PDCCH) monitoring.

Aspect 23: The method of any of Aspects 16-22, wherein the random access procedure is a contention free random access (CFRA) procedure, and wherein the PRACH transmission counting control information is included in UE-specific signaling.

Aspect 24: The method of any of Aspects 16-23, wherein the random access procedure is a contention free random access (CFRA) procedure, and wherein the PRACH transmission counting control information is included in a dynamic cancellation indication.

Aspect 25: The method of any of Aspects 16-23, wherein the random access procedure is a contention free random access (CFRA) procedure, and wherein the PRACH transmission counting control information is included in a dynamic slot format indicator (SFI).

Aspect 26: The method of any of Aspects 16-25, wherein the multiple PRACH transmissions include a number of PRACH transmissions, and wherein the PRACH counting control information indicates whether a dropped PRACH transmission is to be counted in the number of PRACH transmissions.

Aspect 27: The method of Aspect 26, wherein the PRACH counting control information indicates that the dropped PRACH transmission is to be counted in the number of PRACH transmissions.

Aspect 28: The method of Aspect 26, wherein the PRACH counting control information indicates that the dropped PRACH transmission is not to be counted in the number of PRACH transmissions.

Aspect 29: The method of any of Aspects 16-28, wherein the multiple PRACH transmissions include a number of PRACH transmissions, and wherein the PRACH counting control information indicates whether a PRACH transmission that is dropped in connection with a collision with a synchronization signal block (SSB), a collision with a scheduled downlink reception, or a dynamic cancellation indication is to be counted in the number of PRACH transmissions.

Aspect 30: The method of any of Aspects 16-29, wherein the multiple PRACH transmissions include a number of PRACH transmissions to a source cell in a dual active protocol stack (DAPS) based handover, and wherein the PRACH counting control information indicates whether a PRACH transmission that is dropped in connection with a random access channel (RACH) occasion associated with the PRACH transmission overlapping in time with an uplink communication to a target cell is to be counted in the number of PRACH transmissions.

Aspect 31: A method of wireless communication performed by an apparatus of a user equipment (UE), comprising: receiving, from a network node while operating in a connected state, configuration information that indicates dedicated random access channel (RACH) resources for multiple physical random access channel (PRACH) transmissions; and transmitting, to the network node, the multiple PRACH transmissions, in a contention based random access (CBRA) procedure, using the dedicated RACH resources.

Aspect 32: The method of Aspect 31, wherein the configuration information indicates whether to transmit the multiple PRACH transmissions using a same spatial transmission filter or different spatial transmission filters, and wherein transmitting the multiple PRACH transmissions comprises: transmitting the multiple PRACH transmissions using the same spatial transmission filter or different spatial transmission filters based at least in part on the configuration information.

Aspect 33: The method of any of Aspects 31-32, wherein the configuration information indicates a mapping between a synchronization signal block (SSB) and multiple spatial transmission filters, and wherein transmitting the multiple PRACH transmissions comprises: transmitting each PRACH transmission of the multiple PRACH transmissions using a respective spatial transmission filter of the multiple spatial transmission filters based at least in part on the mapping between the SSB and the multiple spatial transmission filters.

Aspect 34: The method of any of Aspects 31-33, wherein the configuration information indicates a number of the multiple PRACH transmissions.

Aspect 35: The method of any of Aspects 31-34, wherein the configuration information indicates a spatial transmission filter configuration for the multiple PRACH transmissions.

Aspect 36: A method of wireless communication performed by an apparatus of a network node, comprising: transmitting, to a user equipment (UE) while the UE is operating in a connected state, configuration information that indicates dedicated random access channel (RACH) resources for multiple PRACH transmissions; and receiving, from the UE, the multiple PRACH transmissions, in a contention based random access (CBRA) procedure, using the dedicated RACH resources.

Aspect 37: The method of Aspect 36, wherein the configuration information indicates whether the UE is to transmit the multiple PRACH transmissions using a same spatial transmission filter or different spatial transmission filters.

Aspect 38: The method of any of Aspects 36-37, wherein the configuration information indicates a mapping between a synchronization signal block (SSB) and multiple spatial transmission filters.

Aspect 39: The method of any of Aspects 36-38, wherein the configuration information indicates a number of the multiple PRACH transmissions.

Aspect 40: The method of any of Aspects 36-39, wherein the configuration information indicates a spatial transmission filter configuration for the multiple PRACH transmissions.

Aspect 41: A method of wireless communication performed by an apparatus of a user equipment (UE), comprising: receiving, from a first network node, a configuration for a dual active protocol stack (DAPS) based handover from the first network node to a second network node; transmitting, during the DAPS based handover, an uplink transmission to the second network node; and transmitting, during the DAPS based handover, multiple physical random access channel (PRACH) transmissions to the first network node in respective random access channel (RACH) occasions, in accordance with a rule for counting a PRACH transmission that is dropped in connection with a RACH occasion associated with the PRACH transmission overlapping in time with the uplink transmission to the second network node.

Aspect 42: The method of Aspect 41, wherein transmitting the multiple PRACH transmissions to the first network node in respective RACH occasions in accordance with the rule comprises: transmitting the multiple PRACH transmissions to the first network node to satisfy a target number of PRACH transmissions, wherein the PRACH transmission that is dropped in connection with the RACH occasion associated with the PRACH transmission overlapping in time with the uplink transmission to the second network node is counted in the target number of PRACH transmissions.

Aspect 43: The method of Aspect 41, wherein transmitting the multiple PRACH transmissions to the first network node in respective RACH occasions in accordance with the rule comprises: transmitting the multiple PRACH transmissions to the first network node to satisfy a target number of PRACH transmissions, wherein the PRACH transmission that is dropped in connection with the RACH occasion associated with the PRACH transmission overlapping in time with the uplink transmission to the second network node is not counted in the target number of PRACH transmissions.

Aspect 44: The method of any of Aspects 41-43, wherein the uplink transmission to the second network node includes at least one of a physical uplink control channel (PUCCH) transmission, a physical uplink shared channel (PUSCH) transmission, a sounding reference signal (SRS), a PRACH transmission, or a Msg3 PUSCH transmission.

Aspect 45: A method of wireless communication performed by an apparatus of a first network node, comprising: transmitting, to a user equipment (UE), a configuration for a dual active protocol stack (DAPS) based handover from the first network node to a second network node; and receiving, from the UE during the DAPS based handover, multiple physical random access channel (PRACH) transmissions in respective random access channel (RACH) occasions, in accordance with a rule for counting a PRACH transmission that is dropped in connection with a RACH occasion associated with the PRACH transmission overlapping in time with an uplink transmission to the second network node.

Aspect 46: The method of Aspect 45, wherein receiving the multiple PRACH transmissions in accordance with the rule comprises: receiving the multiple PRACH transmissions, wherein the PRACH transmission that is dropped in connection with the RACH occasion associated with the PRACH transmission overlapping in time with the uplink transmission to the second network node is counted in a target number of PRACH transmissions.

Aspect 47: The method of Aspect 45, wherein receiving the multiple PRACH transmissions in accordance with the rule comprises: receiving the multiple PRACH transmissions, wherein the PRACH transmission that is dropped in connection with the RACH occasion associated with the PRACH transmission overlapping in time with the uplink transmission to the second network node is not counted in a target number of PRACH transmissions.

Aspect 48: The method of any of Aspects 45-57, wherein the uplink transmission to the second network node includes at least one of a physical uplink control channel (PUCCH) transmission, a physical uplink shared channel (PUSCH) transmission, a sounding reference signal (SRS), a PRACH transmission, or a Msg3 PUSCH transmission.

Aspect 49: An apparatus for wireless communication at a device, comprising a processor; memory coupled with the processor; and instructions stored in the memory and executable by the processor to cause the apparatus to perform the method of one or more of Aspects 1-15.

Aspect 50: A device for wireless communication, comprising a memory and one or more processors coupled to the memory, the one or more processors configured to perform the method of one or more of Aspects 1-15.

Aspect 51: An apparatus for wireless communication, comprising at least one means for performing the method of one or more of Aspects 1-15.

Aspect 52: A non-transitory computer-readable medium storing code for wireless communication, the code comprising instructions executable by a processor to perform the method of one or more of Aspects 1-15.

Aspect 53: A non-transitory computer-readable medium storing a set of instructions for wireless communication, the set of instructions comprising one or more instructions that, when executed by one or more processors of a device, cause the device to perform the method of one or more of Aspects 1-15.

Aspect 54: An apparatus for wireless communication at a device, comprising a processor; memory coupled with the processor; and instructions stored in the memory and executable by the processor to cause the apparatus to perform the method of one or more of Aspects 16-30.

Aspect 55: A device for wireless communication, comprising a memory and one or more processors coupled to the memory, the one or more processors configured to perform the method of one or more of Aspects 16-30.

Aspect 56: An apparatus for wireless communication, comprising at least one means for performing the method of one or more of Aspects 16-30.

Aspect 57: A non-transitory computer-readable medium storing code for wireless communication, the code comprising instructions executable by a processor to perform the method of one or more of Aspects 16-30.

Aspect 58: A non-transitory computer-readable medium storing a set of instructions for wireless communication, the set of instructions comprising one or more instructions that, when executed by one or more processors of a device, cause the device to perform the method of one or more of Aspects 16-30.

Aspect 59: An apparatus for wireless communication at a device, comprising a processor; memory coupled with the processor; and instructions stored in the memory and executable by the processor to cause the apparatus to perform the method of one or more of Aspects 31-35.

Aspect 60: A device for wireless communication, comprising a memory and one or more processors coupled to the memory, the one or more processors configured to perform the method of one or more of Aspects 31-35.

Aspect 61: An apparatus for wireless communication, comprising at least one means for performing the method of one or more of Aspects 31-35.

Aspect 62: A non-transitory computer-readable medium storing code for wireless communication, the code comprising instructions executable by a processor to perform the method of one or more of Aspects 31-35.

Aspect 63: A non-transitory computer-readable medium storing a set of instructions for wireless communication, the set of instructions comprising one or more instructions that, when executed by one or more processors of a device, cause the device to perform the method of one or more of Aspects 31-35.

Aspect 64: An apparatus for wireless communication at a device, comprising a processor; memory coupled with the processor; and instructions stored in the memory and executable by the processor to cause the apparatus to perform the method of one or more of Aspects 36-40.

Aspect 65: A device for wireless communication, comprising a memory and one or more processors coupled to the memory, the one or more processors configured to perform the method of one or more of Aspects 36-40.

Aspect 66: An apparatus for wireless communication, comprising at least one means for performing the method of one or more of Aspects 36-40.

Aspect 67: A non-transitory computer-readable medium storing code for wireless communication, the code comprising instructions executable by a processor to perform the method of one or more of Aspects 36-40.

Aspect 68: A non-transitory computer-readable medium storing a set of instructions for wireless communication, the set of instructions comprising one or more instructions that, when executed by one or more processors of a device, cause the device to perform the method of one or more of Aspects 36-40.

Aspect 69: An apparatus for wireless communication at a device, comprising a processor; memory coupled with the processor; and instructions stored in the memory and executable by the processor to cause the apparatus to perform the method of one or more of Aspects 41-44.

Aspect 70: A device for wireless communication, comprising a memory and one or more processors coupled to the memory, the one or more processors configured to perform the method of one or more of Aspects 41-44.

Aspect 71: An apparatus for wireless communication, comprising at least one means for performing the method of one or more of Aspects 41-44.

Aspect 72: A non-transitory computer-readable medium storing code for wireless communication, the code comprising instructions executable by a processor to perform the method of one or more of Aspects 41-44.

Aspect 73: A non-transitory computer-readable medium storing a set of instructions for wireless communication, the set of instructions comprising one or more instructions that, when executed by one or more processors of a device, cause the device to perform the method of one or more of Aspects 41-44.

Aspect 74: An apparatus for wireless communication at a device, comprising a processor; memory coupled with the processor; and instructions stored in the memory and executable by the processor to cause the apparatus to perform the method of one or more of Aspects 45-48.

Aspect 75: A device for wireless communication, comprising a memory and one or more processors coupled to the memory, the one or more processors configured to perform the method of one or more of Aspects 45-48.

Aspect 76: An apparatus for wireless communication, comprising at least one means for performing the method of one or more of Aspects 45-48.

Aspect 77: A non-transitory computer-readable medium storing code for wireless communication, the code comprising instructions executable by a processor to perform the method of one or more of Aspects 45-48.

Aspect 78: A non-transitory computer-readable medium storing a set of instructions for wireless communication, the set of instructions comprising one or more instructions that, when executed by one or more processors of a device, cause the device to perform the method of one or more of Aspects 45-48.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory;
transceiver; and
one or more processors, coupled to the memory and the transceiver, configured to:
receive, via the transceiver and from a network node, physical random access channel (PRACH) transmission counting control information; and
transmit, via the transceiver and to the network node, multiple PRACH transmissions in a random access procedure in accordance with the PRACH transmission counting control information.

2. The UE of claim 1, wherein the PRACH transmission counting control information indicates a rule for counting the multiple PRACH transmissions in connection with dropping at least one of the multiple PRACH transmissions.

3. The UE of claim 1, wherein the PRACH transmission counting control information is included in at least one of a system information block type 1 (SIB1), in information that indicates synchronization signal blocks (SSBs) transmitted by the network node, in information that indicates a frame format, in master information in a synchronization signal block (SSB), or in information that indicates type 0 physical downlink control channel (PDCCH) monitoring.

4-7. (canceled)

8. The UE of claim 1, wherein the random access procedure is a contention free random access (CFRA) procedure, and wherein the PRACH transmission counting control information is included in at least one of UE-specific signaling, in a dynamic cancellation indication, or in a dynamic slot format indicator (SFI).

9-10. (canceled)

11. The UE of claim 1, wherein the multiple PRACH transmissions include a number of PRACH transmissions, and wherein the PRACH counting control information indicates whether a dropped PRACH transmission is to be counted in the number of PRACH transmissions.

12. The UE of claim 11, wherein the PRACH counting control information indicates that the dropped PRACH transmission is to be counted in the number of PRACH transmissions.

13. The UE of claim 11, wherein the PRACH counting control information indicates that the dropped PRACH transmission is not to be counted in the number of PRACH transmissions.

14. The UE of claim 1, wherein the multiple PRACH transmissions include a number of PRACH transmissions, and wherein the PRACH counting control information indicates whether a PRACH transmission that is dropped in connection with a collision with a synchronization signal block (SSB), a collision with a scheduled downlink reception, or a dynamic cancellation indication is to be counted in the number of PRACH transmissions.

15. The UE of claim 1, wherein the one or more processors are further configured to:
receive, via the transceiver and from the network node while operating in a connected state, configuration information that indicates dedicated random access channel (RACH) resources for the multiple PRACH transmissions in a contention based random access (CBRA) procedure, wherein the one or more processors, to transmit the multiple PRACH transmissions, are configured to transmit the multiple PRACH transmissions, in a CBRA procedure, using the dedicated RACH resources.

16. A user equipment (UE) for wireless communication, comprising:
a memory;
a transceiver; and
one or more processors, coupled to the memory and the transceiver, configured to:
receive, via the transceiver and from a network node while operating in a connected state, configuration information that indicates dedicated random access channel (RACH) resources for multiple physical random access channel (PRACH) transmissions; and
transmit, via the transceiver and to the network node, the multiple PRACH transmissions, in a contention based random access (CBRA) procedure, using the dedicated RACH resources.

17. The UE of claim 16, wherein the configuration information indicates whether to transmit the multiple PRACH transmissions using a same spatial transmission filter or different spatial transmission filters, and wherein the one or more processors, to transmit the multiple PRACH transmissions, are configured to:
transmit the multiple PRACH transmissions using the same spatial transmission filter or different spatial transmission filters based at least in part on the configuration information.

18. The UE of claim 16, wherein the configuration information indicates a mapping between a synchronization signal block (SSB) and multiple spatial transmission filters, and wherein the one or more processors, to transmit the multiple PRACH transmissions, are configured to:
transmit each PRACH transmission of the multiple PRACH transmissions using a respective spatial transmission filter of the multiple spatial transmission filters based at least in part on the mapping between the SSB and the multiple spatial transmission filters.

19. The UE of claim 16, wherein the configuration information indicates at least one of a number of the multiple PRACH transmissions or a spatial transmission filter configuration for the multiple PRACH transmissions.

20. A UE for wireless communication, comprising:
a memory;
a transceiver; and
one or more processors, coupled to the memory and the transceiver, configured to:
receive, via the transceiver and from a first network node, a configuration for a dual active protocol stack (DAPS) based handover from the first network node to a second network node;
transmit, via the transceiver and during the DAPS based handover, an uplink transmission to the second network node; and
transmit, via the transceiver and during the DAPS based handover, multiple physical random access channel (PRACH) transmissions to the first network node in respective random access channel (RACH) occasions, in accordance with a rule for counting a PRACH transmission that is dropped in connection with a RACH occasion associated with the PRACH transmission overlapping in time with the uplink transmission to the second network node.

21. The UE of claim 20, wherein the one or more processors, to transmit the multiple PRACH transmissions to the first network node in respective RACH occasions in accordance with the rule, are configured to:
transmit the multiple PRACH transmissions to the first network node to satisfy a target number of PRACH transmissions, wherein the PRACH transmission that is dropped in connection with the RACH occasion associated with the PRACH transmission overlapping in time with the uplink transmission to the second network node is counted in the target number of PRACH transmissions.

22. The UE of claim 20, wherein the one or more processors, to transmit the multiple PRACH transmissions to the first network node in respective RACH occasions in accordance with the rule, are configured to:
transmit the multiple PRACH transmissions to the first network node to satisfy a target number of PRACH transmissions, wherein the PRACH transmission that is dropped in connection with the RACH occasion associated with the PRACH transmission overlapping in time with the uplink transmission to the second network node is not counted in the target number of PRACH transmissions.

23-30. (canceled)
